(19) United States
(12) Patent Application Publication
(10) Pub. No.: US 2012/0021303 A1
(43) Pub. Date: Jan. 26, 2012

(54) ELECTRICALLY RECHARGEABLE, METAL-AIR BATTERY SYSTEMS AND METHODS

(76) Inventors: Steven Amendola, Easton, PA (US); Michael Binder, Brooklyn, NY (US); Phillip J. Black, McConnellsburg, PA (US); Stefanie Sharp-Goldman, East Brunswick, NJ (US); Lois Johnson, Edison, NJ (US); Michael Kunz, Saylorsburg, PA (US); Michael Oster, Red Bank, NY (US); Tesia Chciuk, Bethlehem, PA (US); Regan Johnson, Fairfield, PA (US)

(21) Appl. No.: 12/841,115

(22) Filed: Jul. 21, 2010

(51) Int. Cl. H01M 8/22

(52) U.S. Cl. 429/406; 429/403

(57) ABSTRACT

The invention provides for a fully electrically rechargeable metal-air battery systems and methods of achieving such systems. A rechargeable metal air battery cell may comprise a metal electrode an air electrode, and an aqueous electrolyte separating the metal electrode and the air electrode. In some embodiments, the metal electrode may directly contact the electrolyte and no separator or porous membrane need be provided between the air electrode and the electrolyte. Rechargeable metal air battery cells may be electrically connected to one another through a centrode connection between a metal electrode of a first battery cell and an air electrode of a second battery cell. Air tunnels may be provided between individual metal air battery cells. In some embodiments, an electrolyte flow management system may be provided.

### BACKGROUND OF THE INVENTION

With a combination of an aging electrical grid infrastructure and integration of intermittent generation sources that come from large scale renewable energy resources such as wind, solar, and ocean waves, there is an increasing and critical need to develop effective energy storage technologies to achieve power supply stability of the grid and to shift electric power supply during peak and off peak periods. Utilities are looking for ways to help add clean power to the grid, prevent power outages and manage peak loads in a cost effective way without adding additional generating capacity. Batteries are considered critical elements in the expansion and large-scale adoption of renewable energy sources such as wind power and solar farms.

To date no battery system has been a commercial success in this application for several reasons. One reason is that the cost of existing battery systems is currently too high. Consequently, utilities primarily use gas turbines to provide peak power as needed. However, they are not as versatile or useable as true storage devices such as batteries. Current battery cycle life is too low, making true lifetime costs much higher than the initial cost. Also many batteries (such as sodium-sulfur batteries) operate at elevated temperatures, contain hazardous chemicals, may have flammable materials, or may be subject to runaway reaction such as those occurring in lithium based batteries. In short, there is no current commercial battery technology that offers large scale battery size, suitable performance, and long discharge/charge cycle life at a commercially viable price and a viable lifetime for utilities.

Therefore, a need exists for improved battery systems. A further need exists for rechargeable battery configurations that are commercially viable.

### SUMMARY OF THE INVENTION

To overcome all of these problems a new electrically rechargeable metal-air system design/chemistry has been provided in accordance with an aspect of the invention. The metal-air cell design incorporates a substantial number of novel and previously unexplored chemical, materials, structural, and design changes. These important changes and modifications will be described in greater detail below. In some embodiments, this metal-air cell may be a zinc-air cell. Independent third party testing to date has verified that the proposed zinc-air cell could be discharged and charged over 200 times with no evidence of air cathode degradation, thus a longer life is expected. Some (or all) of the modifications listed herein may be combined to obtain cell performance with long cycle life that may make this zinc air system affordable and practical.

An aspect of the invention is directed to a rechargeable metal air battery cell comprising a metal electrode; an air electrode; and an aqueous electrolyte between the metal electrode and the air electrode, wherein the metal electrode directly contacts the electrolyte and no separator is provided between the air electrode and the metal electrode. In some additional embodiments, no separator is provided between the air electrode and the electrolyte.

Another aspect of the invention is directed to a rechargeable metal air battery cell system comprising a metal electrode; an air electrode; and an aqueous electrolyte solution having a pH in the range of about 3 to about 10, wherein the battery cell system is capable of at least 500 discharge and recharge cycles without physical degradation of the materials or substantial degradation of the battery cell and system's performance.

A battery cell assembly may be provided in accordance to another aspect of the invention. The battery cell assembly may comprise a cell comprising a metal electrode, an air electrode, and electrolyte between them; and a second cell also having a metal electrode, an air electrode, and electrolyte between them. These two cells are connected in a manner where the metal electrode of cell #1 contacts the air electrode of the cell #2. This allows an air space or tunnel to be formed between the metal electrode of cell #1 and the air electrode of cell #2. In this configuration, the metal electrode and air electrode are parallel to each other and horizontally oriented. In some embodiments, the metal electrode and air electrode may be substantially vertically aligned.

An additional aspect of this invention provides an energy storage system comprising: an electrolyte supply assembly having a flow control feature configured to distribute electrolyte, as needed, to an underlying metal air battery cell; and one or more metal air battery cells comprising at least one port having an overflow portion, wherein the flow control feature allows excess or surplus electrolyte to overflow in each cell if electrolyte volumes increase considerably or to fill individual cells with electrolyte if electrolyte volumes in a particular cell decrease. In some embodiments, the flow control features may be vertically aligned over the overflow portion.

A method for storing energy may provide another aspect of the invention. The method may comprise receiving an electrolyte at an electrolyte supply tank; allowing, if overflow occurs at the electrolyte supply tank, some electrolyte to fall from an electrolyte supply tank to an underlying first metal-air battery cell; and allowing, if overflow occurs at the underlying metal-air battery cell, some electrolyte to fall from the underlying first metal-air battery cell to a second metal-air battery cell or a collection tank. This electrolyte cascading effect assures that electrolyte levels in all cells are full (to maintain good electrical contact) and approximately equal and level electrolyte volumes even with expansion, contraction or evaporation of electrolyte.

Additional methods may be provided in accordance with other aspects of the invention. A method for storing energy may comprise providing one or more bipolar air electrodes with an air space between (which may be called “centrodes”), more specifically having a metal electrode of a first cell in contact with an air electrode of a second cell, wherein an air tunnel is provided between the metal electrode and the air electrode; and providing a first frame extending over the one or more centrodes and a second frame extending below the one or more centrodes, wherein the first cell comprises the space over the metal electrode and enclosed by the first frame for accepting an electrolyte and the second cell comprises the space below the air electrode and closed by the second space for accepting an electrolyte. In some embodiments, a centrode may be provided as described or illustrated elsewhere herein.

A system for storing utility-scale energy, provided in accordance with an aspect of the invention, may comprise a plurality of vertically stacked metal-air cells comprising at least one frame, wherein one or more air tunnels are provided between individual cells; an electrolyte flow management system that is configured to distribute electrolyte to one or more cells or cell stacks; and an air flow assembly configured to provide air flow through the one or more air tunnels. In some embodiments, the electrolyte management system may be integral to one or more frames.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of potential or preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows rechargeable metal-air cells arranged in a horizontal orientation in accordance with an embodiment of the invention.

FIG. 2 shows an example of individual cells that may be stacked on top of one another.

FIG. 3 shows a single cell isometric section view in accordance with an embodiment of the invention.

FIG. 4A shows a system for maintaining a substantially constant and uniform electrolyte level within an arrangement of cells that are horizontally arranged, which may share a common electrolyte fill port and recirculation tank in accordance with an embodiment of the invention.

FIG. 4B shows an additional system for maintaining electrolyte levels within a plurality of cells with side by side cells sharing fill ports and a separate tank or charger to swap spent electrolyte for charged electrolyte (with zinc metal or a zinc slurry) in accordance with another embodiment of the invention.

FIG. 5 shows an example of a battery stack configuration.

FIG. 6 shows an example of a centralized electrolyte management port for an energy storage system that allows each cell to fill and cascade or overflow into other cells in accordance with an embodiment of the invention.

FIG. 7 shows an additional view of a battery stack configuration with metal electrode-air electrode connections vertically and also with horizontal redundancy to bypass a failed cell.

FIG. 8A shows an example of an insulated cargo container and HVAC machine utilization for a battery module with a separate stack of trays with an upper tank and a lower drain, to be part of an electrolyte recirculation system in accordance with an embodiment of the invention.

FIG. 8B shows individual trays of cells at bottom of battery modules with pipes that are part of a recirculation system on the container floor in accordance with an embodiment of the invention.

FIG. 8C shows a number of battery modules assembled in a battery system with recirculation tanks and inverters or other power control equipment.

FIG. 8D shows a top view of a battery system including a plurality of battery modules within a container.

FIG. 8E provides an example of an air flow assembly.

FIG. 8F provides an additional view of an air flow assembly.

FIG. 8G provides an alternative example of an air flow assembly.

FIG. 8H provides an example of a battery system within a container.

FIG. 9A provides a bottom view of a cell frame assembly or tray with electrical connections at the end of each row that are horizontally connected.

FIG. 9B shows a view of a cell frame or tray assembly and one or more centrodes.

FIG. 10 provides a top view of four cells in a horizontal assembly positioned to share a common fill and exit port, which may be referred to as a “quad”.

FIG. 11A shows a top view of an energy storage system with shared fill and overflow port among cells in accordance with an embodiment of the invention.

FIG. 11B shows a side view or cross section of an energy storage system from FIG. 11A, angled to burp or release gas with gravity, with a gravity-fed water supply tank above.

FIG. 12 provides a schematic of a three electrode design for an electrically rechargeable metal air cell.

FIG. 13 shows an example of cell voltage over test time in accordance with an embodiment of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides electrically rechargeable metal-air battery systems and methods. Various aspects of the invention described herein may be applied to any of the particular applications set forth below or for any other types of battery systems. The invention may be applied as a standalone system or method, or as part of a grid/utility system or a renewable energy storage system or method. It shall be understood that different aspects of the invention can be appreciated individually, collectively, or in combination with each other.

### Metal-Air Battery

Metal air batteries have potential for very high energy densities at low cost. Metal air battery systems use atmospheric oxygen as their cathode reactant, hence the “air” in its name. Metal air batteries are unique power sources in that one of the reactants—oxygen—is not stored within the battery itself. Instead, oxygen gas, which constitutes about 20 percent of ambient air may be taken from the unlimited supply of surrounding air as needed and allowed to enter the cell where it is reduced by catalytic surfaces inside an air electrode. Oxygen gas may be essentially an inexhaustible cathode reactant. Because oxygen gas need not be carried within the cell, overall cell weights, volume, or size may be relatively low and energy densities (cell ampere-hour capacities per given cell weight) may be high. For example, cell weights and volume may be lower than cell weights of other battery configurations and energy densities may be higher than energy densities for other battery configurations. Another advantage is the small volume and weight taken up by air electrodes, which can result in higher specific characteristics of the system (Ah/kg and Ah/l) compared to other electrochemical power sources.

Metal-air battery systems may generate electricity by coupling an oxidation reaction at a reactive metal electrode, which, during cell discharge may act as an anode together with oxygen reduction reaction at a cathode containing suitable oxygen reduction catalysts. Generated free electrons from the zinc anode may travel to the air electrode acting as a cathode through an external load.

However, a key drawback of metal-air type batteries may be that they typically have not been electrically rechargeable for large number of discharge and charge cycles. A discharge-charge cycle is defined here as one full electrical discharge followed by a full electrical charge. In some embodiments, a full electrical discharge can last about 6 hours while a follow up full charge can also last about 6 hours. This 12 hour round trip discharge and charge cycle (with the possibility of shorter duration charges and discharges to stabilize or regulate the grid) could be characteristic and expected for a typical one full day of backup service on the electrical grid. Electrical rechargeability may be necessary or highly desirable for any battery that is to be considered for grid applications. Traditional large scale metal air batteries are either not at all electrically rechargeable or may only be cycled for less than a few hundred discharge charge cycles. Furthermore, traditional large metal air battery systems are not readily available commercially. To be practical for utility applications, an electrically rechargeable battery should preferably deliver at least 3500 to 10,000 high performance discharge and charge cycles with good overall efficiency. This would correspond to an approximate 10-30 year life.

Within a metal-air type battery, the electrically conducting electrolyte connecting the metal electrode and air electrode is usually a liquid solution (in some embodiments water-based, aqueous) containing dissolved salts. Metal-air batteries may be thought of combining desirable properties of both fuel cells and batteries: the metal (e.g. Zinc) is the fuel, reaction rates can be controlled by varying the air flow, and oxidized metal/electrolyte paste can be replaced with fresh metal or paste. A tremendous safety advantage of metal air cells is the fact that they are inherently short circuit proof. Since metal air cells are limited by the amount of oxygen they can continually withdraw and utilize from ambient air, they are ultimately limited by how much current they can produce. When a short circuit occurs inside a cell, unlike other battery chemistries, a metal air cell simply does not supply unlimited current—the current delivering capability has a maximum, an upper limit. This is an important safety consideration. Metal air battery systems can include, but are not limited to, aluminum-air, magnesium-air, iron-air, lithium-air, sodium-air, titanium-air, beryllium-air, and zinc-air.

Zinc, in particular, has a number of advantages over other metals. However, any of the embodiments discussed elsewhere herein may also be applied to any type of metal-air battery system which may or may not include zinc. Any reference to zinc as an anode can also be applied to any other metal, and vice versa. Any reference to zinc-air batteries can be applied to any other metal-air batteries and vice versa.

Zinc may be an advantageous material because it is lightweight, non-toxic, inexpensive, readily available, and has rapid electrochemical reaction rates for plating during electrochemical charging. Because of this, zinc-air cells have been used as primary (throwaway) and rechargeable (reusable) cells. Zinc air cells may be recharged either mechanically or electrically. In mechanically rechargeable (refuelable) cells, consumed zinc may be physically removed from a cell/battery and mechanically replaced with fresh zinc. Spent zinc may be processed separately at a different location back to metallic zinc. Such mechanically rechargeable batteries can be used for a grid storage application in some embodiments.

In preferable embodiments, electrically rechargeable cells may be used. In the more practical electrically rechargeable cells, electricity from an external source can be used to generate oxygen at the air electrode, while zinc metal may be electrochemically re-deposited (plated) back onto the metal electrode, to reconstitute the original metal electrode. Both of these zinc air systems typically use alkaline aqueous electrolytes based on highly caustic potassium hydroxide, KOH.

During normal cell operation during cell discharge, oxygen from surrounding air may be reduced (gains electrons) while the reactive metal undergoes oxidation (loses electrons). In zinc air cells containing alkaline electrolyte, for example, the following simplified cell reactions may occur:

At the anode:

2Zn+4OH—→2ZnO+2H₂O+4e⁻ E₀=1.25V

At the cathode:

O₂+2H₂O+4e⁻→4OH⁻ E₀=0.40V

Overall reaction:

2ZnO+O₂→ZnO E_{(OCV)}=1.65V

In some instances, the actual anode reaction products are not simply ZnO+H₂O but rather Zn(OH)₄²⁻. The overall anode reaction could therefore be written as

2Zn+8OH⁻→2Zn(OH)₄²⁻+4e⁻

The generated zinc oxidation product, potassium zincate, can remain in solution.

Zinc air rechargeable cells that use alkaline electrolytes may have a number of technical issues. The first issue is that as air enters the cell, CO₂, carbon dioxide (normally present in ambient air) may enter as well and slowly reacts with alkaline electrolyte to form insoluble carbonate species. These insoluble carbonates precipitate within pores of the air electrodes and also in the electrolyte. This generated precipitate lowers electrical conductivity of the electrolyte, and, because air electrode pores are being blocked by insoluble material, air electrode performance is markedly reduced. Although carbon dioxide absorbing systems have been used to remove (scrub) CO₂ from incoming air, the added weight and complexity detracts from advantages of metal air systems that use alkaline electrolyte.

In addition, because commonly used alkaline electrolytes suffer from being deliquescent (absorbing water from the air), in humid environments, excess water may accumulate in these battery systems, causing the air electrode to become flooded with water. Since air (oxygen) cannot readily diffuse through water, less oxygen can enter and become reduced within the air cathode. This may cause alkaline based air cathodes to quickly lose their active properties.

Another issue with traditional alkaline-based zinc air cells is that although ionic conductivity and cell power performance improve with increasing OH— concentration, so does solubility of formed zinc species. This presents a cell design dilemma. On one hand, a higher pH is desirable for improved electrolyte electrical conductivity and good cell capacity. The tradeoff is that higher electrolyte pH can lead to greater solubility of formed zinc discharge product which results in greater shape changes during cell charge and hence lower cycle life. In other words, in a typical cell design, one may select having either good cell capacity with poor cycle life or good cycle life with poor cell capacities. The desired combination of both good cycle life AND good cell capacity is not currently available in electrochemically rechargeable metal air cells.

Yet another issue with typical alkaline electrolytes is that during electrical charging, plated zinc tends to migrate and redistribute over the zinc electrode. After only a few charging cycles, zinc can deposit in unwanted morphologies (e.g. as spongy, mossy, or filamentary/dendritic deposits). A dendritic deposit is a deposit that protrudes out of the normally smooth zinc surface. Irregularly plated zinc particles may have higher electrical resistance and do not mechanically adhere well to each other. These zinc particles may easily flake off metal electrodes to form isolated zinc deposits. All of these factors contribute to reduced battery capacity and reduced power output for traditional zinc air batteries after continued discharge and charge cycles.

### Battery Electrolyte

In accordance with an aspect of the invention, a battery electrolyte may be selected that may improve the performance of a metal-air battery, such as a zinc-air battery. In some embodiments, the battery electrolyte may be an aqueous, chloride based electrolyte. In some embodiments, the electrolyte may have a pH of about 6. The electrolyte may have a pH of 10 or less, or any other pH value mentioned herein or less. In alternate embodiments, the electrolyte may have a pH falling between 3-10, 4-9,5-7, 5.5-6.5, or 5.75-6.25. In some embodiments, an electrolyte may have a pH of about 3, 4, 5, 5.25, 5.5, 5.75, 5.8, 5.9, 5.95, 6, 6.1, 6.2, 6.3, 6.5, 6.75, 7, 8, 9, or 10. In some embodiments, the electrolyte may be alkali. The pH may be relatively pH neutral. In some embodiments, substantially no carbonates are formed as a result of CO₂ present in the air. The electrolyte may be non-dendritic with little or no CO₂ absorption.

A battery provided in accordance with an embodiment of the invention may utilize an aqueous, chloride based electrolyte. Because of lower electrolyte pH, no carbon dioxide (or an extremely low level of carbon dioxide) is absorbed from the air and thus no insoluble carbonates form in either the electrolyte or air electrode. In addition, since chloride based aqueous electrolytes are commonly used in zinc plating industries to deposit smooth and well adherent zinc deposits, zinc plating efficiencies (during cell charging) should be markedly improved.

A preferable chloride-based electrolyte in a zinc air cell is in accordance with an embodiment of the invention. An electrolyte may comprise a mixture of soluble chloride salts in aqueous solution. Soluble chloride salts may have a cation suitable for yielding a soluble chloride salt in an aqueous solution. Cations of suitable chloride salts may include zinc, ammonium, sodium, or any other cation that can yield soluble chloride salts in aqueous solutions. A conductive electrolyte may be a mixture of soluble salts based on sulfates, nitrates, carbonates, hexyluorosilicates, tetrafluoroborates, methane sulfonates, permanganate, hexafluorophosphates, borates, or phosphates, either singly or mixed together in an aqueous solution. If a mixture of chloride electrolytes is used, for example, this new zinc-air cell may be described as:
Zn/ZnCl₂, NH₄Cl, H₂O/O₂ (Carbon)
   Here, reading from left to right, zinc may be the anode. It can be separated from the electrolyte containing ZnCl₂ and NH₄Cl and H₂O. The carbon based air electrode is where O₂ is reduced during discharge and generated during charge.

In some embodiments, KOH or other electrolytes may be used. Such a system may require or utilize the addition of a CO₂ scrubber as a potassium hydroxide electrolyte absorbs CO₂. Any electrolyte known in the art may be used in conjunction with embodiments of the systems and methods described herein.

In some embodiments, oxygen evolution may be enhanced by charging a cell at low current densities. Such current densities may minimize or reduce Cl₂ evolution. Examples of such current densities may include about 1 mA/cm² to about 100 mA/cm². Such current densities may be about less than, greater than or between any of the following current densities: about 1 mA/cm², 5 mA/cm², 10 mA/cm², 20 mA/cm², 30 mA/cm², 40 mA/cm², 50 mA/cm², 60 mA/cm², 70 mA/cm², 80 mA/cm², 90 mA/cm², or 100 mA/cm². The oxygen evolution may also be enhanced by regulating electrolyte pH. Furthermore, oxygen evolution may be enhanced by using an electrode or catalyst having a low over-potential for oxygen evolution.

In some embodiments, the metal electrode may be formed of zinc, may be plated zinc, or may include zinc in any other form such as an alloy. In accordance with one embodiment of this invention, the electrolyte may comprise a mixture of about 15% zinc chloride (ZnCl₂) and about 15% ammonium chloride (NH₄Cl₂) in water by % mass. Electrolyte may alternatively comprise a mixture of about 15% zinc chloride and about 20% ammonium chloride in water by % mass. In some embodiments, the aqueous electrolyte may contain varying amounts of zinc chloride and ammonium chloride or other salts or chlorides such as LiCl. For example, an electrolyte may comprise about 10%, 12%, 13%, 14%, 14.5%, 15%, 15.5%, 16%, 17%, 18%, or 20% zinc chloride or ammonium chloride. In some embodiments, about the same amount or similar amounts of zinc chloride and ammonium chloride may be provided. Other materials may be added to buffer the electrolyte. These could include ammonium citrate or other compatible buffers such as ammonium acetate, or ammonium hydroxide in 1-2% mass. A porous carbon air electrode (cathode) containing Mn or Co based catalysts may assist in the oxygen reduction reaction.

During cell discharge, oxygen from ambient air may enter the cell through a porous air electrode and may undergo reduction at specifically designed catalyst sites in or on the air electrode. The air electrode may be a carbon based electrode. Meanwhile, at the metal electrode (which may be zinc), zinc goes into solution as soluble zinc ions. In the presence of a chloride-based electrolyte, zinc chloride may be somewhat soluble in the aqueous electrolyte. As cell discharge continues and more zinc ions are created, the solubility limit of zinc chloride may be exceeded. This may cause some zinc chloride to be precipitated. Methods for dealing with the precipitation in accordance with an embodiment of the invention will be described in greater detail below. During cell charge, a reverse electrochemical reaction occurs. Oxygen gas is generated at the air electrode while zinc metal may be regenerated (plated) back on to the zinc electrode.

A simplified discharge/charge processes in chloride electrolyte, which may have a pH of about 6, may be described by the following reactions:

### During Cell Discharge

Cathode reaction:

2H++½O₂+2e⁻→H2O

Anode reaction:

Zn→Zn²⁺2e−

### During Cell Charge

Cathode reaction:

H₂O+2Cl⁻→2HCl+½O₂+2e⁻

Anode reaction:

ZnCl₂+2H⁺+2e⁻→Zn+2HCl

Zinc species formed during cell discharge in an ammonium chloride electrolyte could be more precisely described as Zn(NH₃)₂Cl₂.

At the air electrode, oxygen obtained from ambient air may enter the cell through an air permeable, hydrophobic, membrane. During cell charging, oxygen gas may be produced via water electrolysis at the air electrode.

One effect of using chloride based aqueous electrolytes in rechargeable zinc air battery technologies is that during cell charging (under anodic potentials), an unwanted side reaction involving chlorine evolution may possibly occur

2Cl⁻Cl₂(g)+2e⁻ E₀=1.36 V (1)

Generating chlorine may be an undesirable reaction in this electrolyte system since it can lower overall cell charging efficiencies. For example, electrical energy may go into generating chlorine rather than into evolving oxygen. Therefore, it may be desirable for the battery system to be designed so that during cell charging, anodic potentials favor oxygen evolution and minimize chlorine evolution.

2H₂O→4H⁺+O₂(g)+4e⁻ E₀=1.23 V

Although oxygen evolution (reaction 2) with its lower oxidation potential is expected to predominantly occur because it is thermodynamically favored over chlorine evolution (reaction 1), chlorine evolution is a much simpler chemical reaction and has a lower overpotential. This means that in chloride environments, undesirable chlorine evolution may actually become more likely to occur than oxygen evolution.

Chlorine generated may dissolve in water to form hypochlorous acid, HClO. Hypochlorite ions could then decompose into chloride, several known oxidized chlorine species, or even free dissolved chlorine gas depending on the conditions. Even though chlorine gas per-se does not remain intact, this reaction may still be undesirable in our cell since it lowers overall charging efficiencies.

There are a number of practical ways to minimize or reduce undesirable chlorine (or hypochlorite) evolution (or improve oxygen generation efficiencies). Since oxygen evolution is favored under low current density conditions, one possibility may be to lower charging current densities to favor oxygen evolution. In some embodiments, desirable charging current densities may be about 10 mA/cm² to about 200 mA/cm² and can be varied depending on the application up to the maximum charging or discharging current that the battery will tolerate.

Another approach may be to regulate electrolyte pH. At certain pH values, oxygen generation may be more favored than chlorine evolution. Higher pH favors O₂ evolution over Cl₂ evolution. The electrolyte nay be slightly raised and buffered by addition of ammonium hydroxide, ammonium citrate. Chlorine evolution is favored below pH 2. While ammonium chloride acts as a pH buffer in this system, addition of aqueous ammonium hydroxide would raise the electrolyte pH without adversely affecting the electrolyte conductivity or other performance properties.

Another approach may be to use air electrodes or selected catalysts in the air electrode that have high overpotentials for chlorine evolution and very low overpotentials for oxygen evolution. This way, during cell charging, oxygen evolution is favored. This can be achieved either by modifying electrode surfaces (as will be discussed in greater detail further below), or by adding materials like MnO₂, which are well known to have low overpotentials for oxygen evolution. Similarly, addition of various electrolyte salts has been shown to minimize chlorine evolution. Examples of such salts or chemicals may include cobalt chloride, iridium oxide (IrO₂) or soluble Mn salts. Additionally, there are water-soluble additives such as urea which are known to react with chlorine (if it is formed) to produce non toxic, easily vented gases.

It should be understood however, that the use of alkali electrolyte can be used as part of the disclosed system herein if carbon dioxide is removed from the air. If so, all the benefits of a cell as described herein could still be realized.

Zinc Air Cell with Third Electrode

An aspect of the invention may relate to a reversible or rechargeable battery, such as a zinc air cell, having a zinc electrode and a carbon-based cathode for electrochemical reduction of oxygen gas. This type of cathode may also be known as an air cathode since the oxygen that is chemically reduced is typically obtained from ambient air.

In traditional limited electrically rechargeable metal air cells, air electrodes are expected to perform two opposite functions (hence the occasional name bi-functional air electrode). The first function is oxygen reduction (during cell discharge); the second function is oxygen gas evolution (during cell charge).

Since a bi-functional air electrode serves diverse purposes—a reduction and oxidation—there are two main challenges for these air electrodes. Firstly, there are only a handful of conductive materials that will not readily corrode in aqueous electrolytes under these wide shifts in applied electrical potential. This makes selecting an air electrode current collector more challenging. Secondly, generating oxygen gas bubbles during cell charging may introduce pressure and mechanical stresses in the porous carbon structure which weakens this air electrode.

One possible approach is to not require that the same porous air electrode perform both oxygen reduction and oxygen generation reactions. Instead, in some embodiments, a third or auxiliary electrode may be provided, in lieu of the standard air electrode. The auxiliary electrode may exclusively perform cell charging and associated oxygen generation. Thus, one air electrode may be provided exclusively for cell discharge while a second, auxiliary, air electrode is designed and used exclusively for cell charge. This auxiliary electrode may be situated either between the normally used air electrode and metal electrode, or situated on both sides of the metal electrode. Since an auxiliary electrode would usually only be used during cell recharging and generating oxygen, it could then be optimized for recharge (oxygen production) while the traditional air electrode would be optimized for discharge (oxygen reduction).

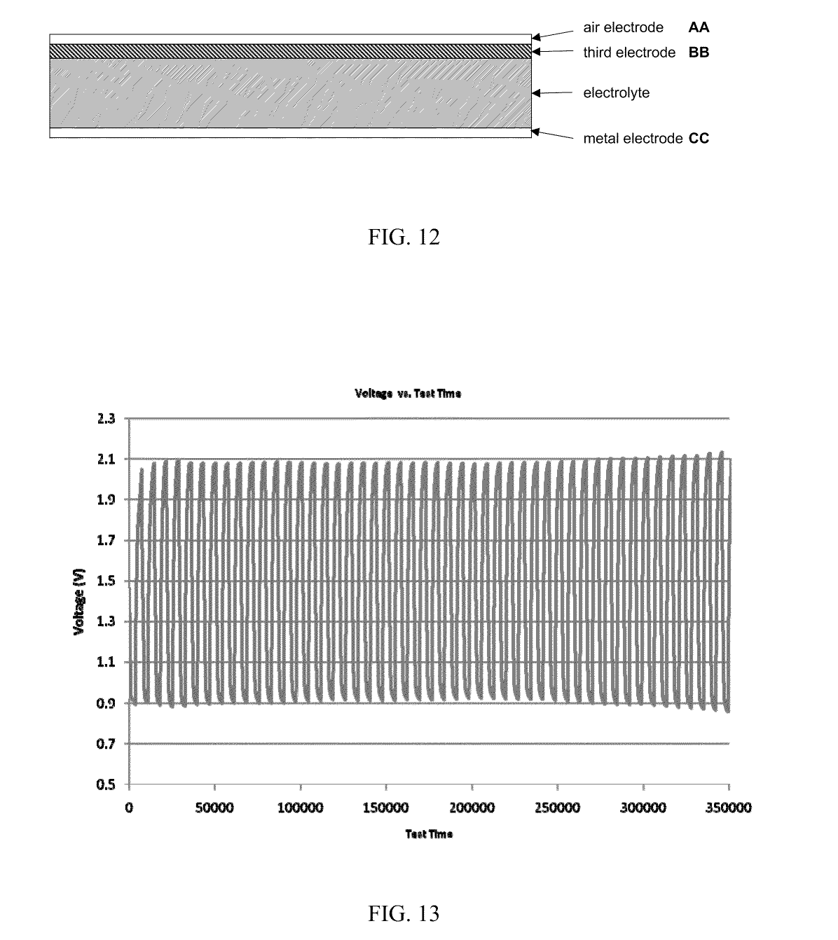

FIG. 12 shows an example of this new electrode configuration. FIG. 12 provides a schematic of a three electrode design for an electrically rechargeable zinc air cell. Here, a traditional porous air electrode (CC) and a solid zinc electrode (AA) are separated by liquid electrolyte. A third, auxiliary electrode (BB), which is only used during cell charge, and electrically isolated from electrode AA, may be situated between electrode CC and electrode AA. In some embodiments, the auxiliary electrode BB may be electrically isolated from electrode AA either by an insulator or by a gap

Electrode AA may be a standard porous carbon air electrode, or any other type of air electrode. Electrode CC may be a zinc metal electrode, or any other metal electrode or anode as described elsewhere herein. A third electrode (BB), which could be a metal screen, foil, mesh, or foam, or pressed or sintered metal powder is only used during cell charging.

During cell discharge, electrodes AA and CC are connected and electrical currents are produced.

During cell charging, electrodes BB and CC may be automatically connected via an electrical switch and electrical currents from an external circuit may be applied across these electrodes.

By using an auxiliary electrode arrangement, a different (possibly cheaper and more efficient) charging electrode may be obtained. During cell discharge, electrodes CC and AA, connected through an external circuit, may provide electrical power. Current flow may be in the same direction as in traditional cells. Oxygen from ambient air may be electrochemically reduced by electrons generated at the zinc electrode.

Prior to cell charging, this third electrode (BB) may be automatically electrically switched into the cell circuitry and electrode AA is disconnected from the metal electrode (CC), such as zinc electrode. Now, during charge, electrodes BB and AA are electrically connected and utilized. Current collectors may be configured to have increased surface areas. These current collectors could be in the form of a mesh, porous plates, wires, screens, foam, pressed or sintered powder, strips, or other suitable open and or high surface area structures. This could allow better contact with electrolyte for oxygen generation reaction. The porous nature of this electrode allows electrolyte to flow through and also allows generated oxygen gas to easily escape. Since O₂ gas is generated at this porous auxiliary electrode, there will be no carbon black to become damaged.

This auxiliary, third electrode may also be designed to contain specific catalysts to enhance O₂ evolution (catalysts having low oxygen overpotentials). In addition, this third electrode may then be protected from reverse currents during cell discharge by using switching diodes that only allow this electrode to be utilized during cell charge.

After the cell has been fully charged, the third (charging) electrode may be disconnected from the cell circuitry and the standard metal electrode and traditional air electrode may be reconnected.

During discharge electrodes AA and CC may be connected.

During charge electrodes BB and CC may be connected.

Any switching or connection/disconnection mechanism known in the art may be used to provide the desired connections during charging and discharging. Such connections may be made in response to instructions provided by a controller.

The recharging air electrode may be made:

1. Larger than the discharge air electrode to allow rapid recharging at lower current densities.

2. Smaller than the discharge air electrode to occupy less volume and not block the air electrode.

### Metal Hydrides as a Battery Anode

In some embodiments of the invention, titanium hydride, TiH₂, may be a suitable metal electrode/anode material in a horizontally configured battery.

Unlike other AB5-type metal hydrogen storage alloys such as LaNi₅, Ti powder and its hydride could be cheaper and have higher energy densities. Also, unlike other metal electrodes that dissolve when undergoing oxidation, TiH₂ does not dissolve following its oxidation. TiH₂ simply becomes solid, metallic Ti.

As an anode, during the cell discharge cycle, TiH₂ may release two protons and two electrons to form Ti metal. During charge, two protons and two electrons may be returned to Ti and TiH₂ may be formed again. The discharge/charge reactions could be:

Discharge:

TiH₂à==>Ti+2H++2e−

Charge:

Ti+2H++2e−à==>TiH₂

Typical metal hydrides deteriorate following numerous discharge/charge cycling due to induced mechanical stresses. This may cause decrepitation and smaller sized metal and metal hydride powders to form. These smaller sized powders do not adhere together well, resulting in lowered electrical conductivity and poor cell performance. However, in conjunction with the present proposed horizontal configured cell design as provided further herein, where metal electrodes are horizontally positioned, the action of gravity may help even finely divided Ti and TiH₂ powder settle back on the current collector below. Even if the metal electrodes are slightly tilted, gravity should nevertheless bring the Ti and TiH₂ powder to settle back on the current collector in a relatively even or uniform fashion. TiH₂ and Ti powders will remain in intimate contact and this metal electrode can continue to undergo oxidation and reduction with good efficiency.

Ti powder may also be modified by treatment via any one of the various treatment processes proposed herein to make Ti more electrically conductive.

Titanium hydride can work as a standard battery or as a titanium-hydride-air battery. Features or portions of the discussion relating to titanium hydride electrodes may also apply to zinc-air batteries or other metal-air batteries and vice versa.

### Horizontal Cell Configuration/Orientation

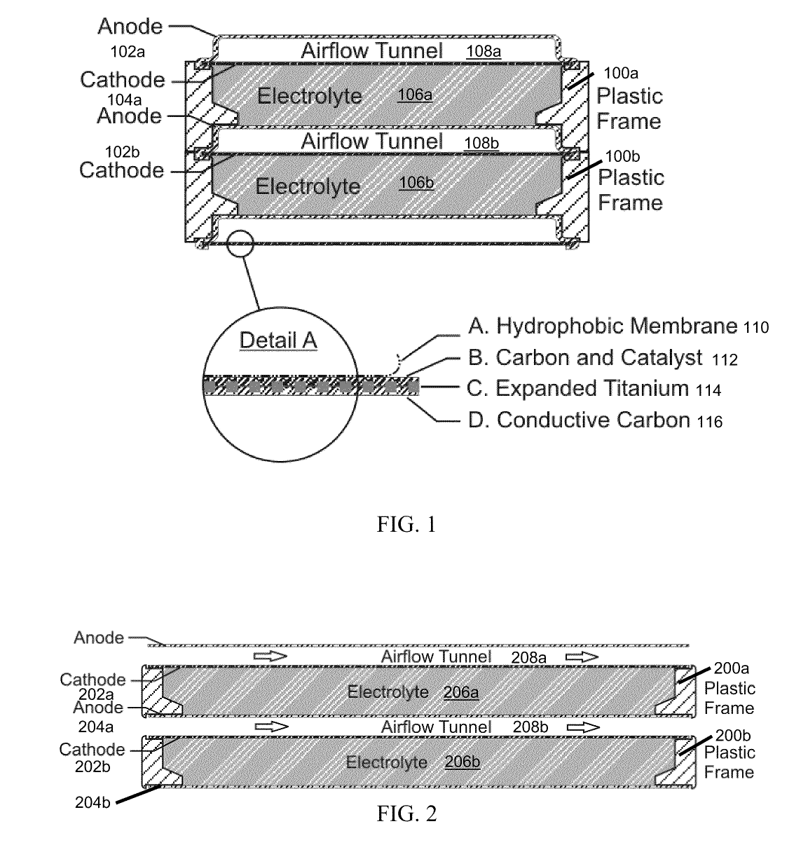

In accordance with another aspect of the invention, a metal-air battery system, such as a zinc-air battery system, may have a horizontal cell configuration. FIG. 1 shows rechargeable zinc-air cells arranged in a horizontal orientation in accordance with an embodiment of the invention. The battery system may include a plastic frame 100a, 100b, an air electrode 102a, 102b, a metal electrode 104a, an electrolyte 106a, 106b, and an airflow tunnel 108a, 108b. In some embodiments, an air electrode 102a, 102b may include a hydrophobic membrane 110, carbon and catalyst 112, expanded titanium 114, and conductive carbon 116. The air electrode may functions as a cathode during cell discharge. The metal electrode functions as an anode during cell discharge. In other words, the air electrode functions as a cathode during cell discharge and the metal electrode functions as an anode during cell discharge. During cell charging, the porous carbon air electrode now functions as an anode while the metal electrode now functions as a cathode. In some embodiments, a metal-air battery cell system may comprise a metal electrode, an air electrode, and an aqueous electrolyte solution. In some embodiments, the electrolyte may have a pH falling within the range of about 3 to 10.

In some examples, a plastic frame may be formed of Noryl, polypropylene (PP), polyphenylene oxide (PPO), polystyrene (PS), high impact polystyrene (HIPS), acrylonitrile butadiene styrene (ABS), polyethylene terephthalate (PET), polyester (PES), polyamides (PA), polyvinyl chloride (PVC), polyurethanes (PU), polycarbonate (PC), polyvinylidene chloride (PVDC), polyethylene (PE), polycarbonate/Acrylonitrile Butadiene Styrene (PC/ABS), or any other polymer or combination thereof. In some embodiments, the plastic used to form a frame may be chosen for its ability to tolerate high temperature, i.e., as high as the boiling point of the electrolyte. In some embodiments, the plastic used to form a frame may be injection moldable. A plastic frame made from injection molded plastic such as, but not limited to, Noryl may be designed to hold both a solid zinc electrode (shown on the bottom of the cell) and an air electrode. The zinc electrode on the bottom of the cell may be separated from an expanded metal titanium current collector screen (embedded within the underside of the porous carbon air electrode by a fixed distance. Filling this separation space between the zinc electrode (metal electrode/anode) and titanium screen current collector (air electrode/cathode) is the electrically conductive, aqueous chloride electrolyte solution.

Frame 100a may surround a cell. An air electrode 102a may be provided as a top layer of a cell. A metal electrode 104a may be provided as an intermediate portion of a cell. An airflow tunnel 108b may be provided between the metal electrode 104a of a first cell and an air electrode 102b of a second cell. An electrolyte 106a may be provided within the cell. The electrolyte 106a may be contained by the frame 100a and may be supported by the metal electrode layer 104a. In alternate embodiments, the positions of the air electrode and metal electrode may be switched so that a metal electrode may be provided as a top layer, and an air electrode may be provided as an intermediate portion

In some embodiments, the air electrode may be a carbon oxygen cathode electrode or polymer based oxygen electrode having an air permeable hydrophobic catalytic membrane, a corrosion resistant metal current collector, wherein during electrical charging under anodic potentials, oxygen evolution may be favored. Air electrodes may also include any materials known in the art.

In some embodiments, low temperature gas plasma treatment may be used to markedly enhance adhesion of metals to various plastics. Gas plasma has been shown to improve adhesion of vapor deposited metals to various polymer surfaces. By treating polymer surfaces with various gas plasmas prior to applying structural adhesives, a stronger, more durable bond, may be formed. Examples of desirable gas plasmas may include O₂, mixtures of CF₄/O₂, or N₂. Such treatment is expected to enhance adhesion of a plastic frame to a metal electrode. In either single cell or multi-cell designs, there may be a number of locations within cell stacks where a plastic surface is adhesively bonded to a metal surface with structural adhesives. This longer lasting seal could translate in a longer lived cell.

There are a number of distinct advantages to having a horizontal electrode orientation. Firstly, a horizontal configuration may allow cells to be rapidly and inexpensively assembled from injection molded plastic containers or frames. Another advantage is that no porous battery separator is needed. In most batteries separating membranes are often expensive and puncturing this membrane is also the key failure mode of these batteries as well. By eliminating a need for a porous battery separator, cells may be more inexpensively and reliably manufactured and used. In some embodiments, an electrolyte within a particular cell may directly contact a metal electrode of that same cell. In some embodiments, the electrolyte may or may not directly contact the air electrode of the cell. No separating layer need be provided between the electrolyte and the metal electrode. In some embodiments, no separation or separating layer may be provided between the electrolyte and the metal electrode and/or air electrode. For example, a rechargeable metal air battery cell may be provided, that has a metal electrode, an air electrode, and an aqueous electrolyte between the metal electrode and air electrode, wherein the air electrode may directly contact the electrolyte and no separator is provided between the air electrode and the electrolyte.

Eliminating a separating membrane is a key to lowering battery costs to affordable levels and helping extend battery cycle life so that it becomes suitable for utility use. By orienting cells so that a metal electrode is on the lower portion, gravity helps keep the plated metal electrode from contacting (and shorting) the air electrode above. In some embodiments, the metal electrode may be a zinc metal anode, and gravity may keep plated zinc from contacting the air electrode above. This creates an extremely reliable battery since there is no membrane to fail and the cell relies on gravity to ensure proper operation. A rechargeable metal air battery system may be capable of a large number of discharge/recharge cycles without physical degradation of materials or substantial degradation of the battery cell system's performance. In some embodiments, the system may be capable of about 100 or more, 200 or more, 300 or more, 350 or more, 400 or more, 450 or more, 500 or more, 700 or more, 1,000 or more, 1,500 or more, 2,000 or more, 3,000 or more, 5,000 or more, 10,000 or more, or 20,000 or more discharge/recharge cycles without substantial degradation.

During cell operation, reaction discharge products may primarily be zinc chloride. When the solubility of zinc chloride exceeds its solubility limits (and since it is formed in chloride-based electrolytes the presence of chloride ions will, via the common ion effect, cause zinc chloride solubility limits to be quickly exceeded) it precipitates. The horizontal configuration together with assistance of gravity should help precipitating zinc chloride particles settle back onto the horizontally positioned zinc metal electrode below. Since zinc chloride particles deposit on/near the zinc electrode, zinc ions will undergo considerably less migration. This means that during cell charge, when zinc is deposited back on the metal electrode, there may be less zinc lost to other locations in the cell. This leads to considerably improved zinc cycling efficiencies and improved cell capacity. Eliminating a membrane separator in rechargeable cells also means that internal resistance losses within cells may be minimized or reduced. This leads to higher operating potentials and less waste heat generated.

A horizontal geometry may also allow for establishing a reproducible fixed distance between the zinc electrode (anode) and current collector of the air electrode. This helps control electrolyte resistance more reproducibly. In some embodiments, a battery cell may have a frame that supports the metal electrode and air electrode at a fixed distance from one another. A fixed distance may define a space in which a liquid electrolyte may be contained. Secondly, in horizontal geometries, where each individual air breathing electrode is facing upwards, numerous zinc air cell assemblies may be stacked on top of each other. This not only increases energy densities (since cells may now be closely packed together) but also allows for designing a battery system with horizontal gas flow manifolds where air may be pumped through battery casings between individual cells to circulate air/oxygen on top of each individual air electrode.

FIG. 2 shows an example of individual cells that may be stacked on top of one another. A cell may include a plastic frame 200a, 200b, an air electrode 202a, 202b, a metal electrode 204a, 204b, and an electrolyte 206a, 206b. The electrolyte may be contained by the plastic frame and may be supported by the metal electrode. In some embodiments, the air electrode may be provided above the electrolyte. The electrolyte may be sandwiched between the metal electrode and air electrode. One or more air flow tunnels 208a, 208b may be provided between the cells. An air flow tunnel 208b may be provided between a metal electrode 204a, and an air electrode 202b.

Thus, two individual cells may be separated from each other by a horizontal air passage or tunnel (not drawn to scale). This horizontal cell configuration may allow air/oxygen to be pumped and circulated between cells to individual air electrodes. Flowing air/oxygen to air electrodes may allow cells to maintain their oxygen supply even at higher current densities and additionally provides cell cooling. Air circulation need not be continually operating and air flow rates may be regulated via feedback mechanisms. In some embodiments, air may flow in the same direction for each of the air flow tunnels. Alternatively, air within different air flow tunnels may flow in varying directions.

In one example, a fan (which may include axial fans, centrifugal fans, cross-flow fans), pump, or any other mechanism for producing airflow may be used. One or more actuators may be part of the air flow mechanism or may be in communication with the air flow mechanism. Examples of actuators may include but are not limited to, motors, solenoids, linear actuators, pneumatic actuators, hydraulic actuators, electric actuators, piezoelectric actuators, or magnets. Actuators may cause the air to flow based on a signal received from a controller. The actuators may or may not be connected to a power source. One or more sensors may be provided in a cell arrangement. In some embodiments, the sensors may be temperature sensors, voltage sensors, current sensors, or pH sensors. These sensors may be in communication with the controller. Based on signals received from the sensors, the controller may provide signals to the air flow mechanisms, which may vary and/or maintain the flow of air between cells.

As previously mentioned, there are a number of advantages of a horizontal geometry in metal-air cells.
A. A horizontal geometry may allow fixed/controlled electrolyte resistance, which may require less cell management.
B. A horizontal geometry may also provide ease of physically assembling and stacking multiple cells.
C. There may be no need for battery separator as gravity may separate materials of different densities.
D. The precipitated discharge product may be helped by gravity, as previously mentioned, to settle as an even or substantially even layer on a metal electrode.
E. A horizontal design may assist in cooling cells and may also allow greater oxygen delivery, which may allow higher currents
F. Gravity may also help to flow electrolyte as later described.
G. Compression may hold cells in place.

A horizontal battery design need not be limited to a metal-air battery, such as a zinc-air battery. A horizontal cell design may be also used in other battery systems where a solid or a slightly soluble discharge product is formed. This may include, but is not limited to, lead-acid (“flooded” and VRLA) batteries, NiCad batteries, nickel metal hydride batteries, lithium ion batteries, lithium-ion polymer batteries, or molten salt batteries.

### Centrode Design for Cell Interconnection

In accordance with an aspect of the invention, systems and methods may be provided for inexpensive, scalable connections between multiple cells.

Interconnecting a number of individual metal air cells in a series electrical connection while maintaining a horizontal geometric configuration for one or more cells (or each cell) may be easily accomplished by what may be referred to as a “centrode.” A “centrode” may be created by taking an air electrode of one cell and crimping it along both sides with a separate metal piece that may be electrically attached to or may itself be the metal electrode in the cell above it. The space between the metal electrode (now positioned on top) and the air electrode (now positioned below) may be separated by a thin air channel 208a, 208b that allows air to be flowed on top of these air electrodes. This is shown in FIG. 2. The resulting centrode sub-assembly resembles a hat section when viewed through the air path 108a, 108b (front to back) as shown in FIG. 1. The metal electrode and the air electrode may be substantially vertically aligned and horizontally oriented.

FIG. 1 illustrates how a metal electrode 104a of a first cell may be crimped around an air electrode 102b of a second cell, thereby connecting the first and second cells in series. The metal electrode of a first cell and an air electrode of a second cell may be electrically connected in any other way. For example, either the metal electrode or the air electrode may be crimped against one another, brazed to one another, welded to one another, pressed against one another, attached with conductive adhesive, soldered to one another or otherwise fastened.

In some embodiments, an air electrode and metal electrode may be separated by a fixed distance wherein the air electrode may be located above the metal electrode. The fixed distance may be uniform across the area of the air electrode and metal electrode. Alternatively, the fixed distance may be varying across the area of the area of air electrode and metal electrode. In some embodiments, the fixed distance may fall in a range that may include about 1 mm, 2 mm, 3 mm, 4 mm, 5 mm, 6 mm, 7 mm, 8 mm, 9 mm, 1 cm, 1.5 cm, 2 cm, 3 cm, or more. The fixed distance between the air electrode and the metal electrode may define a space in which an electrolyte may be contained or provided. The air electrode and metal electrode may be part of the same metal-air cell.

Any number of cells may be assembled, stacked and connected to achieve whatever operating total voltage is required. Each plastic frame may be a common part designed to fit to the shape and sealing requirements of individual centrodes. Each centrode may have unique upper and lower features molded into the plastic. The features molded into the plastic may be the same from cell to cell, or may vary. The molded features may assist with stacking the cells, and for supporting the centrodes within the cells. An automated process assembles the cells in modular fashion by essentially sandwiching multiple centrodes between two corresponding plastic cell frames. This process may be repeated continuously.

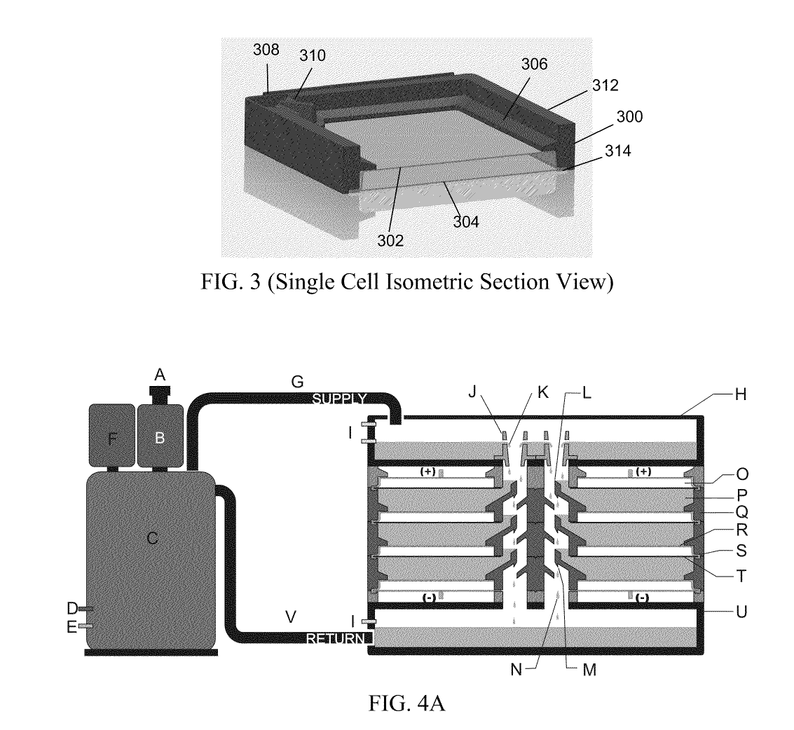

FIG. 3 shows a single cell isometric section view in accordance with an embodiment of the invention. The cell may have a frame 300, metal electrode 302, and air electrode 304. The cell may have desired shape or dimension. For example, the cell may have a rectangular shape, square shape, circular shape, triangular shape, trapezoidal shape, pentagonal shape, hexagonal shape, or octagonal shape. The frame may be correspondingly shaped to fit around the cell.

In some embodiments, a frame 300 may have a vertical portion 312. The frame may also have a horizontal shelf 306 that may protrude within the cell. The shelf may protrude from the vertical portion anywhere along the vertical portion. In some embodiments, the shelf may protrude at or near the bottom of the vertical portion, at or near the top of the vertical portion, or at or near the center of the vertical portion. The vertical portion and/or horizontal shelf may be provided along the entire circumference of the cell or may be provided along one, two, three, four or more sides of the cell. In some embodiments one or more portions of the cell may or may not include a portion of the frame (e.g., the vertical and/or shelf portion of the frame). In some embodiments, the shelf cross-section may be provided as a rectangle, trapezoid, square, any other quadrilateral, triangle, or may have any other shape. In some embodiments, the top surface of the shelf may be tilted. In some embodiments, the top surface of the shelf may be tilted downward toward the center of the cell, or may be tilted downward to the perimeter of the cell. Alternatively, the top surface may be flat with a horizontal orientation.

In some embodiments, a metal electrode 302 may be provided below the shelf 306. In some embodiments, a metal electrode may have a horizontal orientation. The metal electrode may contact the underside of the shelf. In some embodiments, the metal electrode may be shaped to contact one or more vertical sides 312 of the frame. Alternatively, the metal electrode may be shaped to be in close proximity to the vertical side without contacting the vertical side. The metal electrode may be parallel or substantially parallel to the vertical side at that portion.

In some embodiments, the frame may have a bottom feature 314 provided on a lower portion of the cell. In some embodiments, the bottom feature may be an indentation, groove, channel, slot, or hole that may be provided at or near the bottom of the frame. The metal electrode may be shaped to fit within the bottom feature. A portion of the metal electrode fitting within the bottom feature may be parallel or substantially parallel to the surface of the metal electrode spanning the cell. A portion of the metal electrode fitting within the bottom feature may be perpendicular or substantially perpendicular to a portion of the metal electrode contacting or in close proximity to the vertical side.

In some embodiments, an air electrode 304 may span a cell. The air electrode may have a substantially planar configuration. In some embodiments, the air electrode may contact a bottom feature 314 of a cell. In some embodiments, the air electrode may be fitted within the bottom feature of the cell. In some embodiments, a portion of the metal electrode 302 may electrically contact the air electrode within the bottom feature of the cell. For example, the portion of the metal electrode may be crimped around the air electrode within the bottom feature of the cell. In preferable embodiments, a gap may be provided between the portion of the air electrode spanning the cell, and the portion of the metal electrode spanning the cell. Air may be provided within the gap. In some embodiments, air may flow within this gap.

In some embodiments a top feature may be provided on an upper portion of the cell. In some embodiments, the top feature may be an indentation, groove, channel, slot, or hole that may be provided at or near the top of the frame. In some embodiments, the top feature may be a mirror image of the bottom feature. In some embodiments, a top feature may accommodate a metal electrode and/or air electrode above the cell. In some embodiments, an electrical contact between a metal electrode and air electrode may be sandwiched between a bottom feature of a first cell and top feature of a second cell. In other embodiments, a top feature need not be provided. Also, a plastic cell may be injection molded around a centrode or other electrical connections.

Other configurations for frame features, metal electrodes, and air electrodes may be provided. For example, a metal electrode may be provided on top of a shelf. An air electrode may be provided on top of a cell. Positions of metal electrodes and air electrodes may be exchanged.

In some embodiments, a frame may include additional molded features such as a lip 308. The frame may also include a slanted portion 310. In some embodiments, a lip may capture an electrolyte. In some embodiments, some of the electrolyte may be funneled by the slanted portion 310 in a cell. The electrolyte may be contained by the vertical portion 312 of the cell and may be supported by a portion of the metal electrode 302 spanning the cell. In some embodiments, the lip may allow a portion of the electrolyte to flow through the lip portion of the frame and exit beneath the lip portion of the frame. This may prevent or reduce overflow of electrolyte from the cell. In some embodiments, the electrolyte may be provided from within the cell, or may be provided from a source above the cell or may be captured, held or fed to a bladed or expansion chamber pushing up or diagonally up above the cell so that gravity will push the electrolyte back down when there is room in the cell.

An additional advantage of a horizontal configuration is that cells may be designed so that electrolyte management becomes significantly easier. A gravity-based electrolyte management system may be provided in accordance with an embodiment of the invention. As zinc-air batteries discharge, the net volume of the zinc-electrolyte system may increase. If some accommodation is not made, as the electrolyte expands, pressure could build up and liquid electrolyte could penetrate the underside of the air electrode. This may cause flooding of the air electrode and the pressure differential from expanding electrolyte may cause damage to the fragile air electrode. In small, closed batteries, extra space must be allowed for electrolyte liquid expansion. However, this extra volume may lower overall energy density and could create problems in a system where many cells are in series and all cells must maintain a correct electrolyte level. It also does not allow new electrolyte to be fed into the system or the electrolyte to be tested.

In accordance with an aspect of the invention, this issue may be addressed by four horizontally aligned adjacent cells where all four cells share a common corner. This four cell assembly may be referred to as a “quad”. At the point where all four cells meet, the cells could share a filling or overflow or recirculation port. Each cell can be designed to have access to a small port. Each port may have a small overflow lip L that may be tilted slightly above the bottom surface of each air electrode.

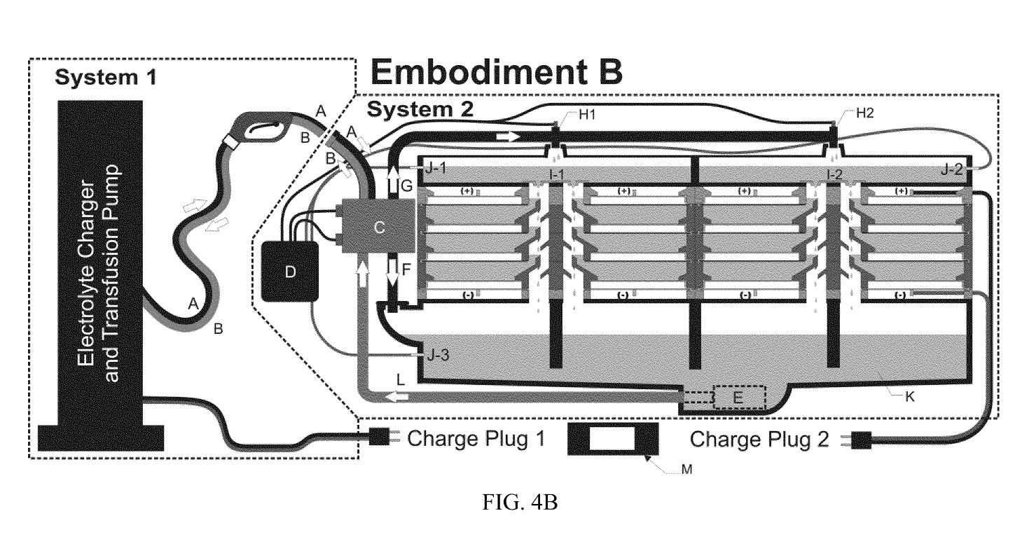

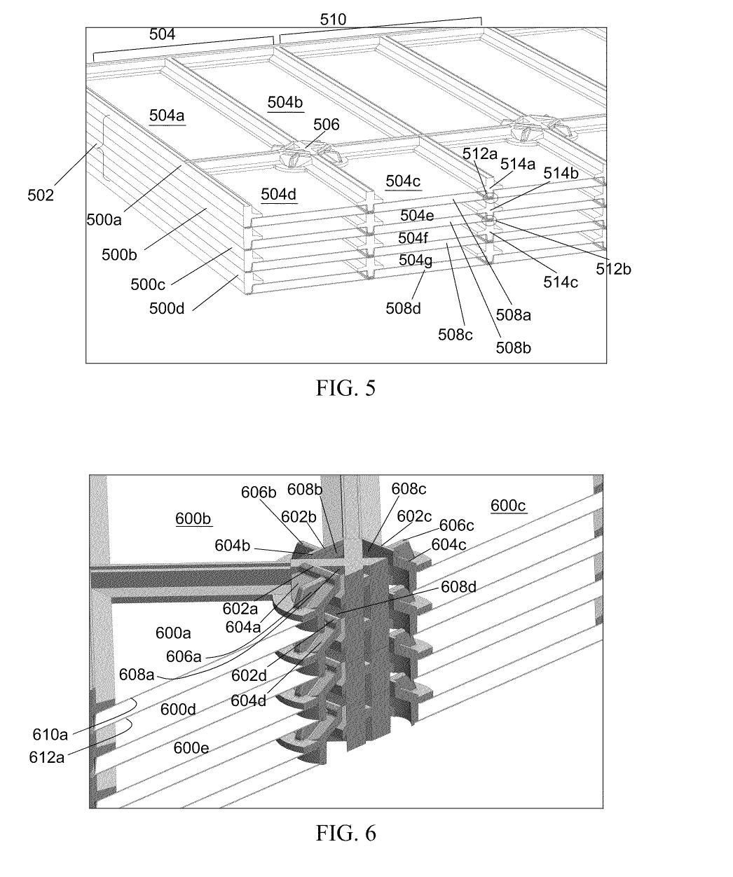

FIG. 5 shows an example of a four cell quad, and FIG. 4A shows a stack of cells in cross section within a gravity-based electrolyte management system. The gravity-based electrolyte management system may include a gas relief channel A, from a tank or container B, which may be in fluid communication with another tank or container C. In some embodiments, valves or entry or exit ports D, E may be provided at a tank. In some embodiments, additional tanks or containers F may be in communication with a main tank or container C. Any distribution of tanks or containers may be provided. These may or may not include filters that may capture unwanted particles. In some embodiments, the tanks may also provide an opportunity to provide any desired additives. As an electrolyte may circulate within an electrolyte management system, it may be replenished as necessary. In some embodiments, the electrolyte may be monitored as it circulates within the system, and modifications to the electrolyte may be made as needed.

A supply fluid passageway G may supply electrolyte to a battery system. A return fluid passageway V may return electrolyte to the battery system. A fluid passageway may include a pipe, tube, channel or any other assembly that may transport fluid. Electrolyte may be supplied to an upper electrolyte tank H. One or more drains or fill port J may be provided. When an electrolyte overflows K the tank, it may drip down into an underlying cell and be caught by an overflow lip L.

An overflow lip L may insure a constant liquid electrolyte level that is always in contact with all points of the underside face of the air electrode T. Electrolyte P may be provided within a cell. During cell discharge when electrolyte expands, this lip may allow excess electrolyte to drain. All of this may be accomplished without putting any hydrostatic pressure on the air electrode. In other words, these unique ports may allow for liquid expansion and gaseous exhaust while maintaining proper (and automatically controlled) electrolyte levels. This electrolyte level balancing may also help maintain uniform electrical performance. These ports (located at the common center of each adjacent four cells—a “quad”) may line up vertically with other ports below to create a series of vertically oriented feeder pipes that may distribute any overflow electrolyte from all parts of the stacked cells within a small sump tray U at the bottom of a stack of cells. These ports may include a prismatic portion M that may break the electrolyte into tiny drops N.

The cells may include an air electrode T and a metal electrode R that may be connected at one or more connection points S. An air tunnel O may be provided between the air electrode and the metal electrode. In some embodiments, the air electrode and the metal electrode may form a centrode. A frame Q may be provided for a cell, quad, or groups of cells or quads. The frames may be stacked within the battery system.

One or more valves or ports I may be provided within an upper electrolyte tank H or sump tray U. The port may allow additives to the electrolyte and/or some of the electrolyte to be drained. A port may allow the venting of gases. In some embodiments, ports may provide access to take measurements. Ports may have other uses.

During cell charge, when electrolyte volumes in each cell decreases, these same fill ports may be used to add liquid electrolyte back into each cell of a “quad”. A sump pump may be triggered to fill the upper “quad” during cell charge. Electrolyte overflowing this uppermost horizontal quad enters the drain pipe and simply fills the horizontal “quad” below it. Automatic filling of quads with electrolyte may proceed quickly until all quads in a vertical stack have been refilled (or topped off) with electrolyte. These fill/overflow ports may be designed to also serve another function. A prismatic protrusion (M) placed under each overflow lip (4-L) may help break apart any electrolyte liquid into small drops (N) before they fall into a quad. This has the effect of breaking any electrically conductive circuit that might have otherwise been created by a continuous conductive liquid flow between individual cells. An unbroken flow of conductive electrolyte could have caused a large electrical short circuit across the high voltage produced by numerous cells stacked in series.

In vertically oriented cells that use conventional plate and frame type configurations, liquid connections between cells can be a source of energy loss and other design problems. The horizontal configuration provided in accordance with embodiments of the invention, with the described fill/overflow port may minimize or reduce these issues with an easily assembled, injection molded, plastic part.

The ease of assembly, modularity and scalability of this design is also readily apparent compared to the difficulties associated with conventional battery assemblies (See FIG. 5).

FIG. 4B shows an additional system for maintaining a constant electrolyte level within a plurality of stacked cells in accordance with another embodiment of the invention. A gravity-flow battery electrolyte management system may include two separate systems. The first system may include a transfusion station with an electrolyte recharger. The second system may include a gravity flow metal-air battery, such as a gravity-flow zinc-air battery.

An electrolyte charger and transfusion pump may be provided in accordance with an embodiment of the invention. The charger may be electrically connected to a charge plug which in turn, may be connected to a power source, such as a grid/utility. A rectifier may be provided to convert AC electricity from a power source to DC to charge the battery. The transfusion system with electrolyte charger may be used for existing fuel stations, residential or fleet use. It may be incorporated into pre-existing structures. The transfusion pump may include one or more electrolyte conducting members A, B which may be a pipe, tube, channel or any other fluid passageway to convey an aqueous electrolyte. A first electrolyte conducting member may be an electrolyte supply A. A second conducting member may be an electrolyte return B. Electrolyte may flow from the electrolyte charger and transfusion pump in the electrolyte supply and may flow to the electrolyte charger and transfusion pump in the electrolyte return. In some embodiments, a pump, valve, pressure differential or any other mechanism may be used to cause electrolyte to flow. In some embodiments, a valve, switch, or locking mechanism may be provided that may stop and/or start electrolyte flow.

A gravity assisted electrolyte flow metal-air battery may include a recharged electrolyte fill tube A, a used electrolyte return tube B, a control valve C, an electronic controller D, a pump E, a supply line to an electrolyte storage tank F, a supply line to upper manifolds G, upper supply control valves H1, H2, upper electrolyte flow controller I1, I2, ports J-1, J-2, J-3, storage tank K, and electrolyte return line from storage tank L. In some embodiments, in a gravity assisted flow design, gravity may push the electrolyte through the cells without requiring a pump to push electrolyte through the cells. In a gravity-flow electrolyte-overflow design, a wicking agent is not required.

An electrolyte fill tube A may provide an electrolyte to the gravity flow metal-air battery. The control valve C may determine whether electrolyte is to be provided to the metal-air battery and how much electrolyte/flow rate need be provided to the battery. The control valve may be directed by an electronic controller D which may provide instructions to the control valve. These instructions may determine how much electrolyte flow the control valve allows. Instructions may be provided automatically from the controller. The controller may or may not be in communication with an external processor, which may provide instructions to the controller. In some embodiments, the controller may have a user interface or may be in communication with an external device that may have a user interface. In some embodiments, a user may be able to communicate with a user interface, and may provide instructions to the controller, which may affect instructions provided to the control valve.

In some embodiments, the metal-air battery may have a pump E that may assist with flow and circulation of the electrolyte. In some embodiments, the pump may be provided in a storage tank K of the metal air battery. An electrolyte return line from the storage tank L may provide electrolyte from the storage tank K to the control valve C. The electrolyte return line from the storage tank may be connected to the pump. The pump may force electrolyte through the electrolyte return line to the control valve. The electronic controller may provide instructions to the control valve that may determine whether electrolyte can return and/or the flow rate at which the electrolyte can return.

A supply line to the storage tank F may be provided. Electrolyte may flow from the control valve C to the storage tank K. A supply line to upper manifolds G may also be provided. Electrolyte may flow from the control valve to the upper manifolds. In some embodiments, one manifold may be provided. In other embodiments, a plurality of upper manifolds may be provided. The upper manifolds may or may not be in fluid communication with one another. In some embodiments, the electrolyte provided through the supply line G may be controlled by one or more upper supply control valves H1, H2. In some embodiments, a control valve may be provided for each upper manifold. The control valve may regulate the electrolyte flow into each upper manifold. The electronic controller D may be in communication with the upper supply control valves. The electronic controller may provide instructions to the upper supply control valves. In some embodiments, instructions provided by the electronic controller may be provided over a wired connection, or may be provided wirelessly.

In some embodiments, upper electrolyte flow controllers I1, I2 may control the electrolyte flow from the upper manifold to the cells below. The flow controllers may break the electrolyte into drops. The flow controllers may control the rate of the fluid being transferred from the upper manifold to the underlying cells.

In some embodiments, the upper manifold and/or the storage tank K may have ports J-1, J-2, J-3. In some implementations the ports may be in communication with the electronic controller D. In some embodiments, ports may provide access to take one or more measurements. The measurements may be communicated to the electronic controller which may provide instructions to other parts of the electrolyte management system. For example, based on the measurements, the electronic controller may cause the flow rate of the electrolyte to be adjusted, the temperature of the electrolyte to be adjusted, the pH of the electrolyte to be adjusted, or the composition of the electrolyte to be adjusted.

An electrical connection may be provided within the battery system. For example, an electrical connection may be provided at a (+) side of the battery and an electrical connection may be provided at a (−) side of the battery, and may be connected to a second charge plug. Charge plug 2 may be plugged into a wall socket, such as a grid/utility. An AC to DC rectifier may be provided that may convert AC from a grid/utility to DC to charge the batteries. An inverter may or may not be provided that may convert DC from the batteries to AC as the batteries are discharged.

In some embodiments, the voltage of the battery system may be monitored. In some embodiments, the voltage of the overall system may be monitored, or the voltage of each module may be individually monitored. When voltage drops unexpectedly, this may indicate a problem with one or more cells. In some embodiments, the system may increase electrolyte flow rate when the voltage drops.

In some embodiments, one or more characteristics of the battery and/or electrolyte may be monitored at a single point. For example, the pH of the electrolyte, temperature of the electrolyte, composition of the electrolyte may be measured at a single point, such as the storage tank. The invention may include a simplified monitoring system that may determine whether the system needs to be adjusted without requiring an expensive and complex sensing system.

### Additives to Improve Zinc Plate Quality and Form Insoluble Zinc Species

Internal resistance (IR) losses can be kept low by plating out a good quality zinc coating during each recharge cycle. A key factor in the longevity of this cell is that no specific electrode shape has to be maintained. Unlike many chemistries such as lead-acid in which the cycling actually damages the electrode, the battery may plate out a fresh coating of zinc each time. The battery system may include additives that may improve zinc deposition on the metal electrode. With key additives such as polyethylene glycol of various molecular weights, and/or thiourea, a fresh, smooth level, highly conductive zinc coating may be plated during each cell recharge cycle. This zinc layer may then undergo oxidation to dissolved zinc ions during the next cell discharge. Since no exact physical shape is required during plating and since gravity helps hold deposited zinc in place, metal electrode failure (quite common in other battery systems) may now be minimized or reduced as a failure mode. This helps achieve a very long cycle life battery.

Another embodiment may include other additives that would cause zinc ions that are generated (during oxidation at the metal electrode during cell discharge) to remain close to the metal electrode so that they will be readily reduced (without excessive migration) during cell charging. It would therefore be useful to have a water soluble additive electrolyte that (once in contact with Zn²⁺ ions formed at the metal electrode) may form an insoluble zinc species that can precipitate to the bottom of horizontally oriented cells. Insoluble zinc species may remain near the zinc electrode and be more easily available for reduction during recharge. The battery system may include an additive that may control desirable precipitation. Such additives may include any of the following water soluble species. Examples of water soluble species that form insoluble zinc species include: benzoates, carbonates, iodates, and stearates.

In some embodiments, additives having any of the properties described herein may include urea, thiourea, polyethylene glycol, benzoates, carbonates, iodates, stearates, water soluble catalyst surfactant, or aloe vera, alone or in combination. In some embodiments, adding aloe vera extract may reduce zinc corrosion.

### Soluble Catalysts as Electrolyte Additive to Improve Oxygen Formation During Recharge

In addition to the solid catalysts incorporated in the air electrode itself other materials such as water soluble manganese salts can be added to improve cell performance during recharge. Since oxygen is generated during cell recharge it is also useful to allow oxygen bubbles to easily escape. This can be accomplished by adding surfactants that act as antifoaming agents (such as Simethicone or Dowex) to break up generated bubbles. The battery system may include an additive that prevents foaming and allows gas release. Additives may include one or more of the following: simethicone, Dowex, aloe vera, or other surfactants.

The air electrode can also be mounted with a small angle to the parallel to assist formed oxygen bubbles to leave a quad via a common fill port near the overflow lip. In some embodiments, expanded titanium could also be disposed with a slight negative crown or stamped perimeter gas relief channel so that it may be ensured that the majority of air electrode surface area is compliant with the electrolyte. Any air bubbles or gases may easily escape via the common fill ports. These configurations will also address flatness tolerance issues and mitigate leveling issues).

### Urea as Electrolyte Additive to Eliminate Formed Chlorine

The battery system may include an additive that prevents chlorine and/or hypochloride evolution during recharge. Urea may be added to the aqueous battery electrolyte to control chlorine generation. Urea and chlorine may react to form chlorides and benign gaseous products (e.g., N₂, CO₂, and H₂). If any free chlorine is formed at all in the electrolyte during cell charging, it may readily react with soluble urea to form additional chloride (which is already an electrolyte component). Generated gases from the reaction of chlorine with urea are not hazardous and may be safely vented. If urea is added to the electrolyte and not replenished, then, as cells are charged (and if chlorine gas is generated), urea may react with formed chlorine, be depleted, and not be available to remove any chlorine gas generated during subsequent charging cycles.

In the cell design provided in accordance with an embodiment of the invention, electrolytes may be periodically tested and, if chlorine levels are above a predetermined level, additional urea may be added as required. In some embodiments, the electrolytes may be manually tested. In other embodiments, one or more sensors may be provided to automatically test the chlorine levels and if necessary, add additional urea to react with and remove chlorine. In some embodiments, urea may be manually added as needed. In alternate embodiments, urea may be automatically added when chlorine levels are above a predetermined level. In some embodiments, the predetermined level may be in the range of 5% urea by weight but typically would be a few ppm urea.

In some embodiments, the battery system may include an additive that may prevent hydrogen evolution during charging. The additive may include high hydrogen overpotential chloride salts such as tin chloride, lead chloride, mercurochloride, cadmium chloride, or bismuth chloride.

Rapid Recharge with Zinc/Electrolyte Slurry

With a horizontal cell design, a system may be provided where cells may be rapidly recharged (e.g., for long range mobile applications). Zinc chloride particles formed during discharge may be rapidly removed from cells via suctioning this slurry into a waste tank or bladder. This used electrolyte liquid may be replaced by fresh zinc pellets in electrolyte slurry that may be pumped back into the horizontal cell. Solid zinc particles may settle to the bottom of the cell (metal electrode). This mechanical recharging is only expected to take a few minutes.

In some embodiments, as shown in FIG. 4B, one or more horizontal cells may be within a housing or may form part of the battery housing. The housing may be connected to a tank. In some embodiments, used electrolyte liquid may be returned to the tank. The electrolyte liquid may be returned via a return pipe, tube, channel, conduit, or any other fluid communications apparatus. In some embodiments, the tank may supply electrolyte liquid to the housing. The electrolyte may be supplied via a supply pipe, tube, channel, conduit, or any other fluid communication apparatus. In some embodiments, the same tank may receive the used electrolyte liquid and provide fresh electrolyte liquid. Electrolyte liquid may cycle within the system. In some embodiments, the tank may have one or more treatment processes that may treat the used electrolyte liquid before it is supplied back to the housing. For example, fresh zinc pellets may be added to the electrolyte. In other embodiments, different tanks may be used to receive the used electrolyte liquid and provide fresh electrolyte liquid. Fresh electrolyte may enter the system, and used electrolyte may be removed from the system.

The zinc chloride particles from the used cell can be regenerated locally or in some regional facility (the equivalent of a refinery or tank farm) by well known electrochemical techniques. Such a modification would convert this system from what would be typically envisioned as a battery to more of a flow type cell or zinc air fuel cell. However, all of the above advantages would still be available, and a longer discharge cycle could be accomplished than a discharge cycle that would be available from just the amount of zinc that can fit into each cell without the circulating of external zinc. Another refueling method could be described as electrolyte transfusion, where degraded electrolyte may be exchanged with fresh electrolyte for fast, convenient refueling, similar to traditional pumping stations.

### Metal-Air Battery Housing and Assembly

As previously described, the metal-air battery system may include a battery housing. This housing may have any number of configurations that may contain one or more enclosed individual cells. In some embodiments, a cell itself may form part of the housing. For example, cells may be stacked so that cell frames may form part of the housing. In some embodiments, the housing may by fluid-tight. For example, the housing may be liquid tight and/or air tight. In some embodiments, the housing may include one or more venting mechanisms.

A. Plastic Housing with Shared Four Cell “Quad” and Electrolyte Fill/Exhaust Port System

The layout and design of a plastic cell frame can be optimized or improved for space efficiency, strength, moldability, and minimized or reduced internal resistance losses due to lowered intercell resistance.

A cell frame design, in accordance with an embodiment of the invention, may incorporate a common centralized electrolyte management system which may be shared by four individually framed, horizontally oriented cells. In other embodiments, the centralized electrolyte management system may be shared by any number of cells, including but not limited to one, two, three, four, five, six, seven, eight, nine, ten, eleven, twelve, thirteen, fourteen, fifteen, sixteen, seventeen, eighteen, nineteen, twenty, or more cells. This design may allow for optimal “centralized” spacing, physical stackability, and electrical connectivity of the manifold system.

FIG. 5 shows an example of a battery stack configuration of an energy storage system. The exterior walls of the plastic frames 500a, 500b, 500c, 500d may form a housing wall 502. In some embodiments, four cells 504a, 504b, 504c, 504d may form a quad 504 with a shared centralized electrolyte management system 506.

Any number of cells may be stacked on top of one another. For example, four cells 504c, 504e, 504f, 504g may be stacked on top of one another. In some embodiments, one or more, two or more, three or more, four or more, five or more, six or more, seven or more, eight or more, nine or more, ten or more, twelve or more, fifteen or more, twenty or more, thirty or more, or fifty or more cells may be stacked on top of one another. One or more air flow passages 508a, 508b, 508c, 508d may be provided for each cell. The plurality of vertically stacked cells may be selected to achieve a desired voltage. If vertically stacked cells are connected in series, the number of vertically stacked cells may correspond to an increased voltage level. As described elsewhere herein, a centrode may be used to create a series connection between cells.

Any number of quads or stacks of quads may be provided adjacent to one another. For example, a first quad 504 may be adjacent to a second quad 510. One or more rows of quads and/or one or more columns of quads may be provided in an energy storage system. In some embodiments, an energy storage system may include an i×j array of quads, wherein i, j are any whole numbers greater than or equal to 1, including but not limited to 1, 2, 3, 4, 5, 6, 7, 7, 8, 9, 10, 11, 12, 13, 14, 15, or more. In other embodiments, cells or quads may have staggered configurations, concentric configurations, or be positioned in any manner with respect to one another. Gaps may or may not be provided between the adjacent cells or quads. Alternatively, adjacent cells and/or quads may be electrically connected to one another. In some embodiments, one or more cells, or one or more quads may share a common frame with the adjacent cell or quad. In other embodiments, each cell or quad may have its own frame which may or may not contact the frame of the adjacent cell or quad.

As previously discussed, any number of cells may share a common centralized electrolyte management system. Four quadrilateral cells may share a common centralized electrolyte management system, forming a quad. In other examples, six triangular cells may share a common centralized electrolyte management system or three hexagonal cells may share a common centralized electrolyte management system. Any combination of cell shapes may be used, wherein a corner of one or more cells may share a common centralized electrolyte management system. Any reference to quads may also be applied to other numbers or configurations of cells that may share a common centralized electrolyte management system. Horizontal and/or vertical cross conductive connections may be provided. This may provide redundancy of connection.

B. Unique Manifold and Gravity Controlled Drip System Design

FIG. 6 shows an example of a centralized electrolyte management system for an energy storage system in accordance with an embodiment of the invention. A plurality of cells 600a, 600b, 600c may share a common electrolyte management system. The electrolyte management system may include a lip 602a, 602b, 602c for each cell. The lip may assist with containing liquid electrolyte within the cell. The electrolyte management system may also include one or more slanted or vertical portions 604a, 604b, 604c. The slanted or vertical portion may direct electrolyte to flow into the cell. In some embodiments, the combination of 11p and slanted or vertical portion may capture electrolyte provided from above the cell. In some embodiments, one or more support protrusions 606a, 606b, 606c may be provided. The centralized electrolyte management system may also include a prismatic protrusion 608a, 608b, 608c that allows overflow electrolyte to drip to underlying cells and/or an electrolyte capturing tank below.

In one example, an electrolyte liquid may be caught by an overflow lip 602a of a first cell 600a. The electrolyte liquid may flow down the slanted or vertical portion 604a and be contained within the cell. If the electrolyte liquid overflows from the first cell, it may be flow over the overflow lip, and into the prismatic protrusion 608a. It may flow through the prismatic protrusion and be caught by the lip 602d and slanted or vertical portion 604d of a second cell 600d below the first cell. Electrolyte may be captured by and contained within the second cell. If the second cell is overflowing or overflows, electrolyte fluid may flow through the prismatic protrusion 608d of the second cell and be caught by a third cell 600e, or may continue flowing downward.

When initially filling a battery system with electrolyte, cells on top may be filled first, and then electrolyte may overflow into underlying cells or quads, which may then flow over into further underlying cells or quads, for however many layers of vertical cells are provided. Eventually, all of the cells in a vertical stack configuration may be filled with electrolyte and excess electrolyte may be captured by a bottom reservoir tray beneath the cells.

Any of the features of the electrolyte management system may be integral to the cell frame or may be separate or separable from the cell frame. In some embodiments, the features may be injection molded.

The electrolyte management system may continually manage liquid electrolyte levels in each four cell “quads” to ensure constant and uniform electrical contact with the lower portion of each air-electrode. Sufficient electrolyte may be provided to the cells so that electrolytes may contact the lower portion (e.g., 610a) of an air electrode. In some embodiments, the lower portion may be a metal electrode/anode. In other embodiments, sufficient electrolyte may or may be not be provided to the cell to ensure electrolyte contacts a bottom portion 612a of an air electrolyte overhead. The bottom portion of the air electrode may be a cathode during discharge.

FIG. 3 provides an additional view of a cell having an electrolyte management system in the corner.

In preferable embodiments, a prismatic protrusion or lip may be configured to break any potential connection of conductive liquid flowing between cells. The prismatic protrusion may break the electrolyte liquid into small sized drops. The prismatic protrusion may control the flow rate of any overflow electrolyte.

The electrolyte management system may be useful for allowing for efficient electrolyte overflow and management. Overflowing electrolyte may be captured by cells below or may flow downwards until it is captured by a tank below.

The electrolyte management system may also allow unwanted, generated gases to be safely vented. In some embodiments, the gases may be vented through passages formed by the prismatic portions, either upward, or downward.

Advantageously, the electrolyte management system may replenish cells with liquid electrolyte via a gravity-controlled, drip system. Cells may be replenished by overflow from cells overhead, or from an electrolyte source. For example, as shown in FIG. 4A, electrolyte may be supplied to an upper holding tank. Electrolyte may be supplied in any other manner.

As provided in embodiments of the invention, a gravity assisted overflow and common refill port for each cell may be generalized and used in any other energy storage device where liquid electrolyte levels may change during discharge and charge. Such liquid management systems need not be limited to metal-air cells, such as zinc air cells. Other types of energy storage cells may utilize similar liquid management systems. The level of liquid electrolyte may automatically be adjusted so that it only touches the lower portion of each individual air electrode.

An additional modification to this design involves fabricating each cell with a recessed cavity contained on one side. This may function as a liquid reservoir where excess electrolyte volumes may be safely stored as needed. When electrolyte volumes decrease, the excess liquid stored in this cavity may automatically flow down via gravity and be used to refill the cell thus assuring that all parts of the electrolyte-facing side (bottom portion) of the air electrode remains in contact with the liquid electrolyte.

C. Compression Design for Reliability

FIG. 5 provides a view of a battery stack configuration. As previously described, in some embodiments, the outer surfaces of the frames of the cells can form a housing. In some embodiments, all critical sealing surfaces may be under vertical compressive load for added long term sealing reliability. For instance, a compressive load may be applied to the stack of cells, which can distribute the compressive load to the frames. This causes frames to be compressed together and form a seal. The compressive load may be provided in a direction that compresses a stack of cells together. The compressive load may be provided in a direction perpendicular to a plane formed by a metal electrode or air electrode of the cell. In some embodiments, the compressive load may be provided in a vertical direction.

Centrode assemblies may be sandwiched between corresponding plastic frames to form a series of individually sealed cells. As previously discussed, centrodes may be formed when a metal electrode of one cell is electrically connected to the air electrode of another cell. In one embodiment, this electrical connection may be formed when a metal electrode is crimped around an air electrode. This may allow a serial connection between cells. In some embodiments, a compressive force may be applied between the cells. The compressive force may be applied to the connection between the metal electrode and air electrode. Applying a force that brings the metal electrode and air electrode together may improve the electrical connection between the metal electrode and air electrode. In some embodiments, the metal electrode and air electrode contact point may be sandwiched between plastic frames, and the compressive load may provide a compressive force between the frames and contacts. A fluid tight seal may be formed, which may prevent electrolyte from flowing from one cell to another via the frame contact with the centrode. This seal may be done or supported with adhesive.

Outer walls and interior partitions (which may form frames of the cells) may be structural members designed to properly house and seal the inner workings of each cell, and apply compressive loads on critical cell joints and sealing surfaces. This provides an easily assembled, reliable design and an advantageous structural system when individual cells are stacked vertically. FIG. 1 and FIG. 2 show how the individual cells may be stacked vertically. In some embodiments, the stack may be loaded with a compressive force which may be applied to the frames and/or connections between the metal electrodes and air electrodes.

D. Metal Electrode, Air Electrode Sub-Assembly

FIG. 1 shows a connection between a metal electrode and air electrode. In some embodiments, a stamped assembly method crimps the metal electrode over the air electrode, forming a hat section for air to pass through. In some embodiments, the metal electrode may be crimped over the air electrode so that a portion of the metal electrode contacts an edge on a first side of the air electrode and an edge on a second side of the air electrode. In other embodiments, the air electrode may be crimped over the metal electrode so that a portion of the air electrode contacts an edge on a first side of the metal electrode and an edge on a second side of the metal electrode. The metal electrode and air electrode may be crimped together in any manner so that they are bent or folded over one another with various configurations. In some embodiments, they are crimped or otherwise attached together so that they contact one another without requiring any bends or folds. Other ways of forming an electrical connection, as mentioned above can be used.

A metal-air electrode assembly may utilize different materials that are crimped to form an electrical flow connection along both sides of the air path. In some embodiments, examples of materials for the metal electrode may include zinc (such as a zinc powdered amalgam), or mercury. Examples of materials for the air electrode may include carbon, Teflon, or manganese.

A metal-air electrode assembly may be provided where the metal electrode provides the sealed floor of the electrolyte pool above, while the air electrode forms the sealed cover for the electrolyte pool below. For example, as shown in FIG. 1, a metal electrode 104a may form the floor of an electrolyte pool 106a. The air electrode 102a may form the cover for the electrolyte pool. The metal electrode and/or air electrode may be sealed.

A centrode formed by the metal electrode and air electrode may have any dimensions. One or more of the dimensions (e.g., length or width) may be about ¼″, ½″ 1″, 2″, 3″, 4″, 5″, 6″, 7″, 8″, 9″, 10″, 11″, 12″ or more.

E. Cross Conductive Design Between Cells

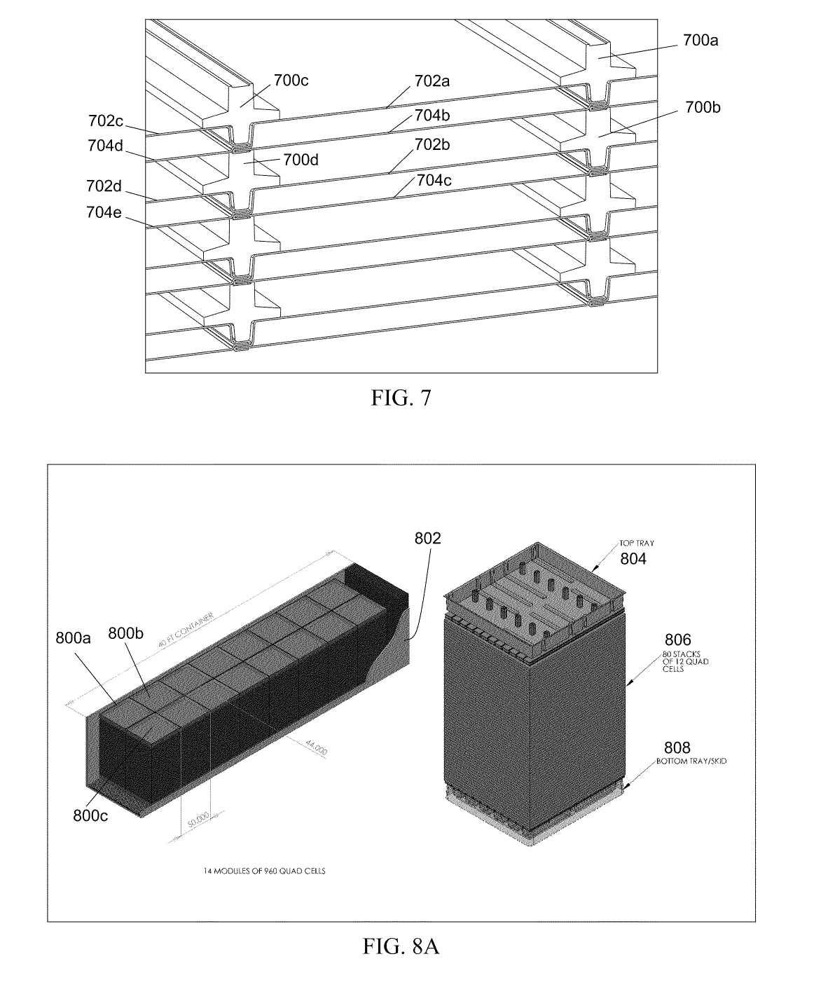

FIG. 7 shows an additional view of a battery stack configuration with metal electrode-air electrode connections. A metal electrode—air electrode assembly configuration may be provided where neighboring crimp flanges or other extensions of centrodes overlap or touch, creating a repeatable, modular and horizontally and vertically electrically connected series configuration.

A first cell may include frame members 700a, 700c, and may have a metal electrode 702a. The metal electrode may be crimped around the air electrode 704b of an underlying cell. In some embodiments, the metal electrode of a neighboring cell 702c may be crimped around the air electrode its underlying cell 704d. In some embodiments, the electrical connection formed by the metal electrode 702a and air electrode 704b may be in electrical communication with the electrical connection formed by metal electrode 704c and air electrode 704d. For example, one of the metal electrodes 702c may contact the other metal electrode 702a. Alternatively, the electrical connection between neighboring cells can be formed by any combination of metal electrodes and/or air electrodes contacting one another. In some embodiments, electrical connections between overlying and underlying cells and adjacent cells (e.g., the connection between 702c, 704d, 702a, 704b) may be provided between frames (e.g., 700c, 700d).

FIG. 7 shows an example of how metal electrodes and air electrodes may make electrical connections by crimping and folding. However, any combination of contacts between metal electrodes and air electrodes folded over or contacting one another may be used in accordance with various embodiments of the invention. The positions of metal electrodes and air electrodes may be reversed in alternate embodiments of the invention, and any discussion relating to metal electrode positions may apply to air electrode positions and vice versa.

Overlapping or otherwise compliant crimp flanges may allow for a series or a series-parallel electrical connection for system reliability, simplicity and flexibility. For example, one advantage of such a system may be that fewer wires and connection points are needed because every row in a cell frame may be electrically connected in series via overlapping crimp flanges.

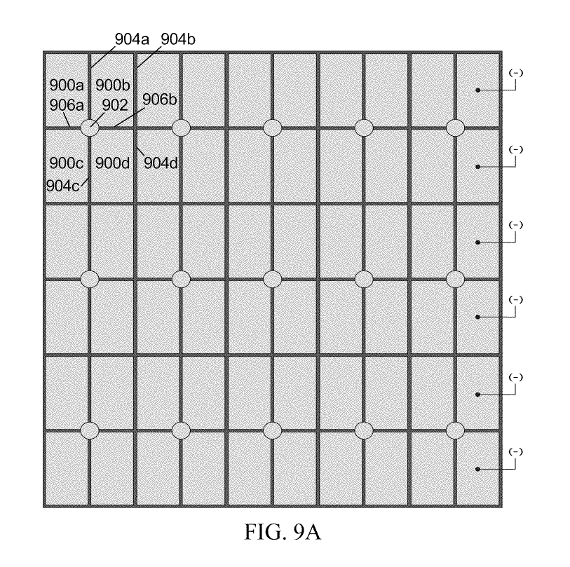

FIG. 9A provides a bottom view of a cell frame assembly with electrical connections. One or more cells 900a, 900b, 900c, 900d may form a quad with a common electrolyte management system 902. The bottom of a cell may be formed of a metal electrode. One or more frame components 904a, 904b, 904c, 904d, 906a, 906b may be provided, separating cells. In some embodiments, electrical connections between cells may be provided for adjacent cells. For example, electrical connections may be provided between two or more cells within a row, such as between a first cell 900a and a second cell 900b. An electrical connection may be provided near a frame 904a between the cells. Electrical connections may be provided between two or more cells within a column, such as between a first cell 900a and second cell 900c. An electrical connection may be provided near a frame 906a between the cells. Electrical connections may be provided for any combination of adjacent cells within a row or column.

In some embodiments, electrical connections are not provided between adjacent cells. In some embodiments, electrical connections may be provided only between overlying and underlying cells forming a stack.

FIG. 9B shows a view of a frame assembly and one or more centrodes. A frame 880 may be providing for one or more single cells or quads, or a plurality of single cells or quads. One or more centrodes 882a, 882b may be formed of a metal electrode 884 and an air electrode 886. A centrode may be shaped to fit within the frame. In some embodiments, the frame may rest on the centrodes so that a side portion of the frame forms a wall of a cell and the metal electrode of the centrode forms the floor of the cell. A plurality of adjacent centrodes, e.g., 882a, 882b may be electrically connected to one another. For example, a centrode may have a point where the metal electrode and air electrode contact one another 888. The contact point of a first cell may contact a contact point of the second cell. In some embodiments, the centrode may be formed so that an air tunnel 890 is provided between the metal electrode and the air electrode.

The frame 880 may include an electrolyte distribution assembly 892 that may be integrally formed into the frame. The electrolyte distribution assembly may include a slot 894 that may allow electrolyte to flow to underlying cells. The electrolyte distribution assembly may include an overflow lip 896 that may determine when an electrolyte overflows into the slot. In some embodiments, the height of the overflow lip may provide tolerance for when the cells or overall battery system is tilted. Even if the overall battery system is tilted, if the overflow lip is sufficiently high, sufficient electrolyte will be retained within the cells before overflowing.

The frame may also include a shelf 898 that may protrude from the frame. The metal electrode 884 may contact the shelf. In some embodiments, a fluid-tight seal may be formed between the metal electrode and the shelf. The contact between the metal electrode and the air electrode 888 may contact a bottom portion of the frame 881. The bottom portion of the frame may rest on top of the contact point. A fluid tight connection may or may not be formed. A bottom portion 883 of a frame may rest on top of a contact point formed between adjacent centrodes.

F. Stackable Configuration & Modular Assembly

FIG. 5 shows a design that utilizes one plastic frame component that essentially sandwiches multiple centrodes between two of the common frames. This may advantageously provide a simplified design. For example, as shown, a frame may be provided forming a grid pattern that can span multiple cells. The grid-pattern frames can be stacked on top of one another. In some embodiments, grid-pattern frames may be formed of a single integral piece. Alternatively, the grid-pattern frames may be formed of multiple pieces that may be connected to one another. The multiple pieces may or may not be detachable. Centrodes 512a, 512b may be provided between the frames 514a, 514b, 514c.

The frame design may include a water management system. The water management system may be provided in FIG. 4, which may show water inlets, elevated overflow ports and prismatic drip edges, as previously described. The water management system may be used to ensure a desired electrolyte level within one or more cells.

When stacked, the plastic frame design can form a series of vertical tubes or pipes that allow for water overflow, drip replenishment of electrolyte and gas exhaust. As previously discussed in relation to FIG. 4 and FIG. 6, an electrolyte management system may be provided. When the frames are stacked on one another, the electrolyte management system may be provided for stacks of cells.

The stackable frame assembly configuration may be both modular and efficient. The plastic features may conform to the mating shape of the metal electrode below and the air electrode above the cell beneath it, which may allow for a modular configuration with fewer parts. FIG. 1 and FIG. 2 provide an example of a stack of cells with features in the frames that may be molded to conform to the metal electrode and air electrode connection. Depending on the shape of the metal electrode and air electrode connection, the frames may be shaped to conform to the connection shape. In some embodiments, one or more ridges, grooves, channels, protrusions, or holes may be provided on the plastic frame to complement a corresponding shaped feature of the metal electrode-air electrode connection. In some embodiments, the complementary shape may keep the frame from shifting horizontally in one or more directions. Any features may be integral to the cell or separable from the cell. In some embodiments, frame features may be injection molded.

G. Modular Installation and Utilization Configurations

Multiple battery configurations can be achieved by scaling the frame design up or down. For example the frame design can include a single cell frame, quad cell frame, or multiple quads in a single frame. The frame design for each grouping (e.g., single cell, quad cell, multiple quads) can be formed of a single integral piece. Alternatively, the frame design could include multiple parts.

In some embodiments, multiple frames may also be provided adjacent to one another. For example, multiple single-cell frames, quad-cell frames, or multi-quad frames may be provided adjacent to one another. Frames provided adjacent to one another may or may not be connected to one another using a connector. In some embodiments, a force may be provided to hold the frames against one another.

Frames may be stacked to any desired height depending on power and storage demands. Any number of frames may be stacked on top of one another. For example, one or more, two or more, three or more, four or more, five or more, six or more, seven or more, eight or more, nine or more, ten or more, twelve or more, fifteen or more, twenty or more, thirty or more, sixty or more, ninety or more, 120 or more, or 150 or more frames may be stacked on top of one another. In some embodiments, each frame may be about ⅛″, ¼″, ½″, ¾″, 1″, 1.25″, 1.5″, 2″, 2.5″, 3″, 4″, 5″, 6″, 8″, 10″, or 12″ tall. In some embodiments, an overall height of a stack of frames may be in the order of about 1 or more inches, 3 or more inches, six or more inches, 1 or more feet, 2 or more feet, 3 or more feet, 5 or more feet, 10 or more feet, or 20 or more feet.

Stacks of individual frames may be oriented in various directions to optimize air circulation. For example, air tunnels may be provided within cells. In some embodiments, the air tunnels may be provided between cells. For example, a continuous air tunnel may be formed between adjacent cells. Air tunnels may be provided for columns of cells and/or for rows of cells. In some embodiments, the air tunnels may be parallel to one another. In other embodiments, one or more air tunnels may be perpendicular to one another. In some embodiments, air tunnels may be formed of a straight line, or in other embodiments, air tunnels may have bends or curves. In some embodiments, when cells may be slightly tilted, air tunnels may be substantially horizontally oriented but have a slight rise and fall to accommodate the tilt of the cells. Air may flow in the same direction for parallel air tunnels, or may flow in opposite directions. In some embodiments, an air tunnel may be confined to a single level. In other embodiments, passages may be provided that may allow an air tunnel to be provided over multiple levels of the stacks. Any combination of these configurations may be utilized.

A stack or series of stacks can be utilized in various configurations and installed in various housings. For example, stack heights may vary. Similarly, the number of cells provided per level of a stack may vary. In some embodiments, individual cell sizes or shapes may be uniform, while in other embodiments, individual cell sizes or shapes may vary. Housing sizes may vary depending on the size of the stacks. For example, an overall energy storage system may have one or more dimensions (e.g., height, width, length) on the order of inches, feet, tens of feet, or hundreds of feet. Each dimension may be within the same order of magnitude, or may be within varying orders of magnitude.

A stack or series of stacks can be configured as a fuel cell system via the exchange or replenishment of electrolyte, and the packaging of said support systems. For example, a zinc-air fuel cell system may include the addition of zinc metal and the removal of zinc oxide. As previously mentioned, zinc pellets may be added to the electrolyte. Zinc oxide or zinc chloride may be removed to a waste tank.

H. Insulated Cargo Container and HVAC Machine Utilization

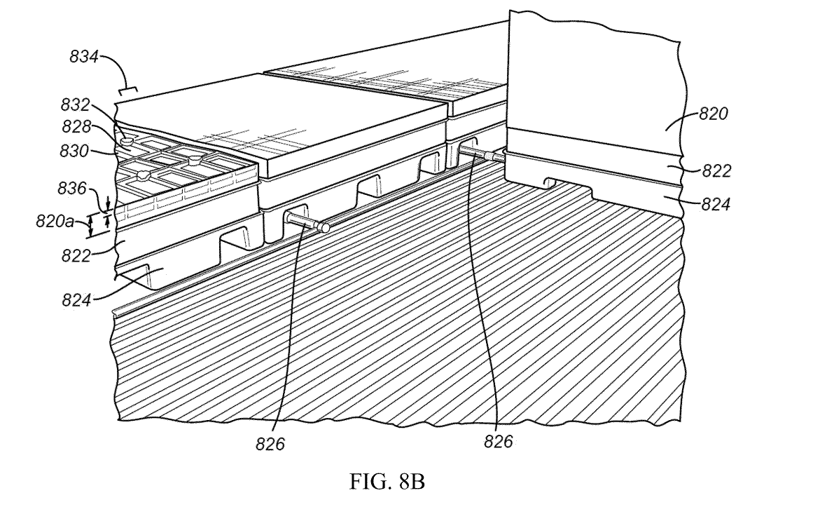

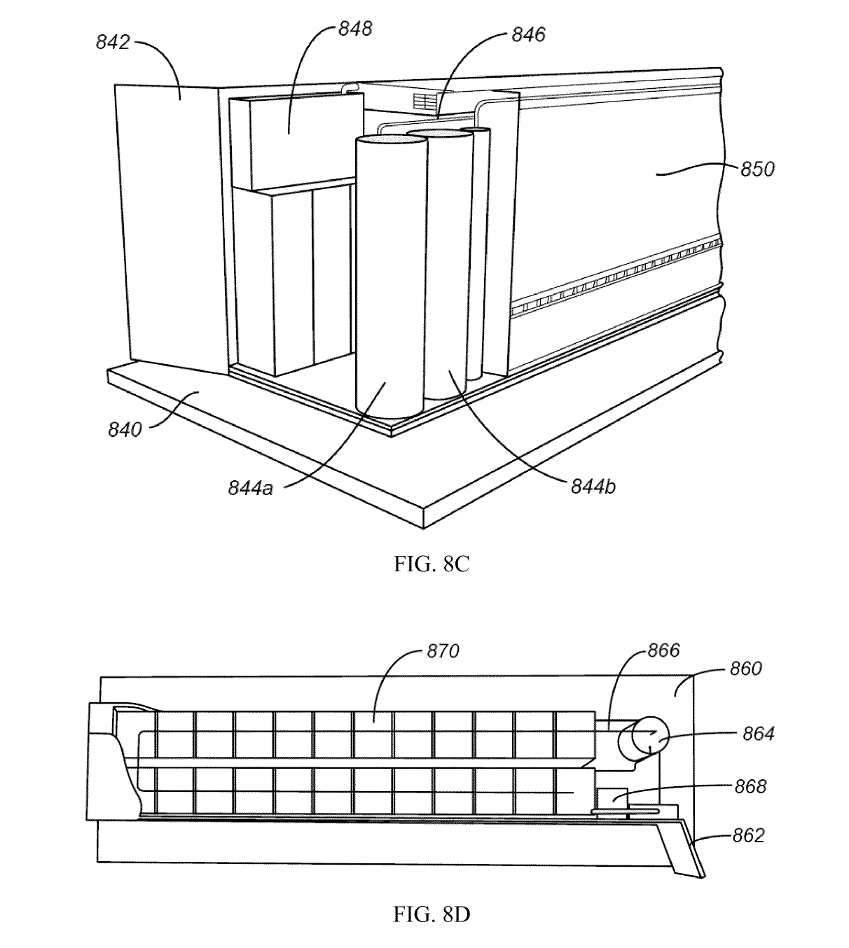

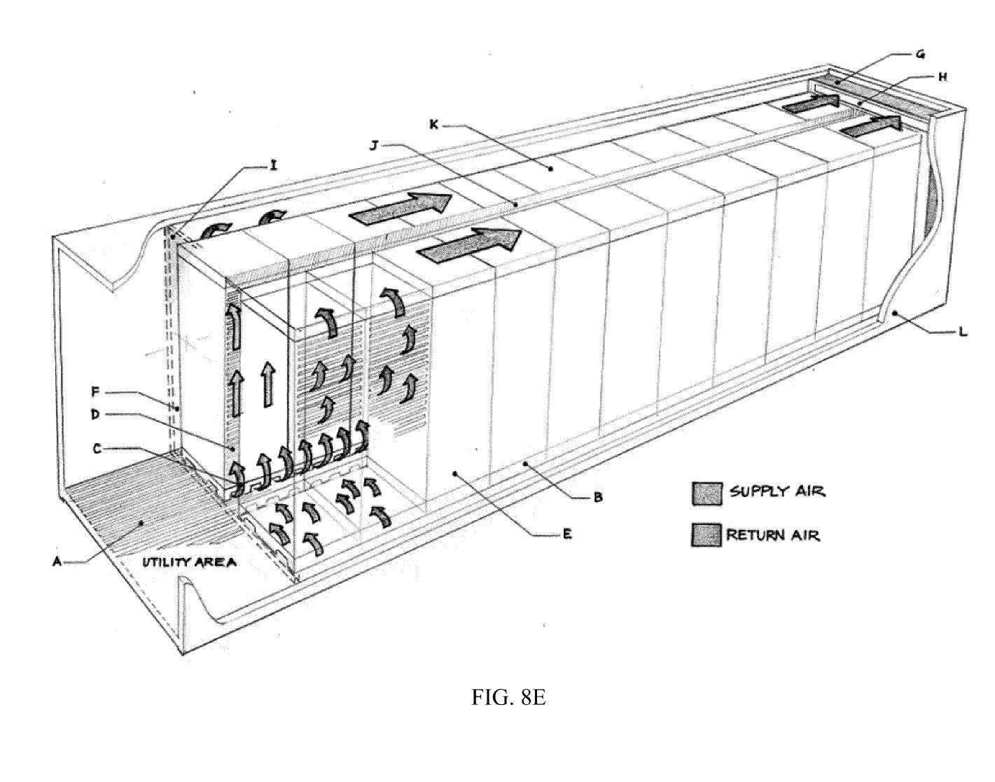

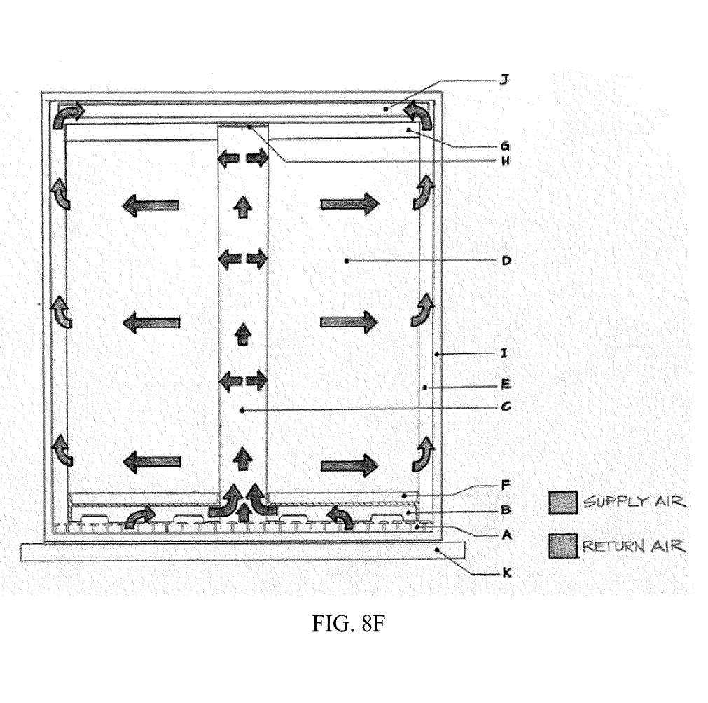

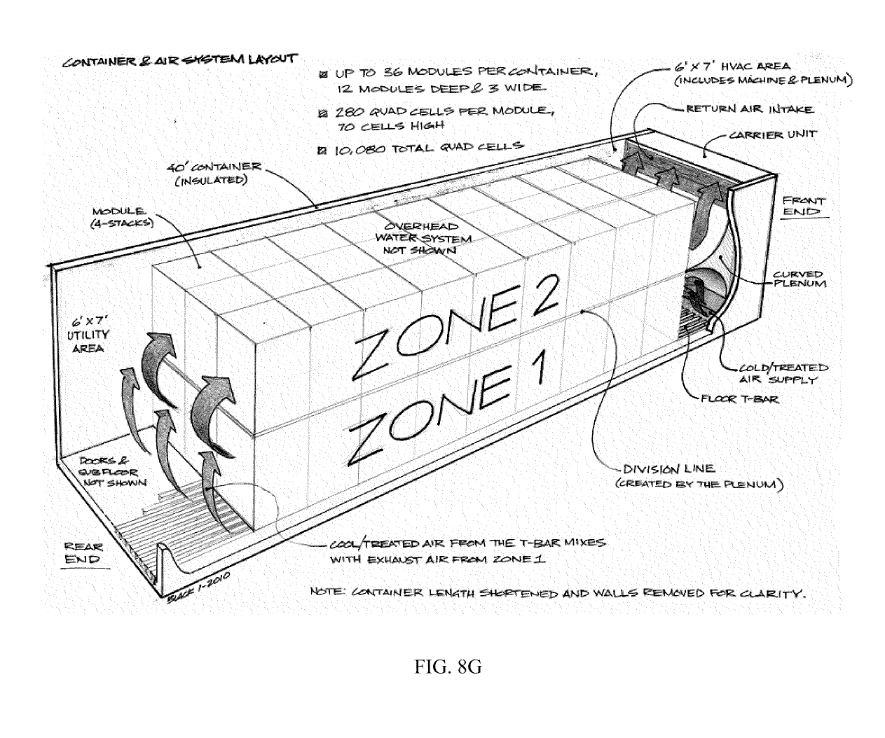

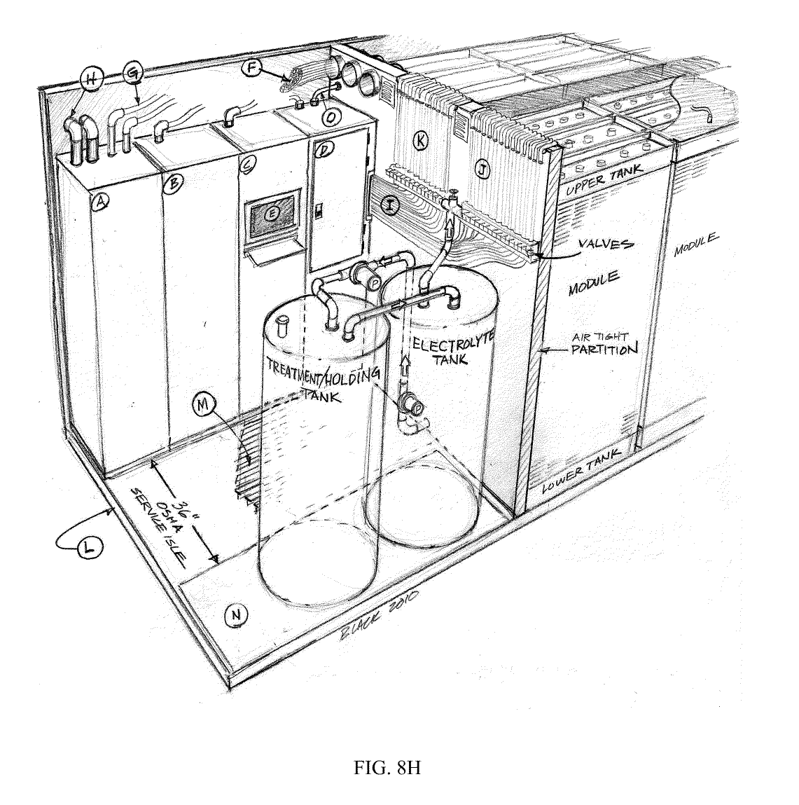

FIG. 8A shows an example of an insulated cargo container and HVAC machine utilization for a battery stack in accordance with an embodiment of the invention. A plurality of modules 800a, 800b, 800c may be provided within a housing 802. Each module may have a top tray 804, one or more stacks of cells (which may include one or more levels/layers of single cells, quad cells, and/or any number of cells) 806, and a bottom tray or skid 808. See also FIG. 8H. and each stack of cells might have a manifold whereby electrolyte can be sent or disconnected to a given stack or section of a stack. Similarly, electrical connections can be segregated and disconnected to certain stacks.

In one example, 16 modules 800a, 800b, 800c of 960 quad cells may be provided. Two rows, each having eight modules may be provided. In various embodiments of the invention, any number of modules may be provided, including but not limited to one or more, two or more, three or more, four or more, five or more, six or more, seven or more, eight or more, nine or more, ten or more, twelve or more, fifteen or more, twenty or more, thirty or more, fifty or more, or a hundred or more modules. In some embodiments, the modules may be arranged in one or more rows and/or one or more columns. In some embodiments, the modules may be arranged in an array. A housing 802 may be shaped to fit the modules. In some embodiments, the housing may be about 40, 45, 50 or 52 feet long.

A module may have any dimensions. In some embodiments, a module may be about 50 inches by 44 inches. In one example, a module may comprise 80 or 120 or more stacks of 15 or more or less quad cells. However, a module may be formed of any numbers of levels/layers in stacks, including but not limited to 1 or more layers, 2 or more layers, 3 or more layers, 5 or more layers, 10 or more layers, 20 or more layers, 30 or more layers, 40 or more layers, 50 or more layers, 60 or more layers, 70 or more layers, 80 or more layers, 90 or more layers, 100 or more layers, 120 or more layers, 150 or more layers, or 200 or more layers. Each stack layer may include any number of single or quad cells. For example, each stack level/layer may include 1 or more, 2 or more, 3 or more, 4 or more, 5 or more, 6 or more, 7 or more, 8 or more, 9 or more, 10 or more, 12 or more, 14 or more, 16 or more, 20 or more, 25 or more, 30 or more, 36 or more, 40 or more, 50 or more, or 60 or more single cells or quad cells per level/layer.

In some embodiments, a module may include a top tray 804. The top tray may be configured to accept electrolyte. In some embodiments, the top tray may be configured to distribute the electrolyte to one or more cells. The top tray may be in fluid communication with electrolyte management systems of the cells. In some embodiments, the top tray may be in fluid communication with one or more cells. The top tray may include one or more protrusions. The one or more protrusions may provide structural support for a cover over the tray. The top tray may include one or more channels or grooves. In some embodiments, the top tray may include one or holes or passageways providing fluid communication to the underlying layers.

A module may also include a bottom tray or skid 808. In some embodiments, the bottom tray or skid may collect electrolyte that may overflow from the stacks overhead. The bottom tray or skid may contain the collected electrolyte or may transfer it elsewhere.

A modular design may be crafted to fit in various standard ISO cargo containers in an optimized fashion. In some embodiments, a housing may be an ISO cargo container. The housing may have a length of about 20 ft (6.1 m), 40 ft (12.2 m), 45 ft (13.7 m), 48 ft (14.6 m), and 53 ft (16.2 m). An ISO container may have a width of about 8 feet. In some embodiments, a container may have a height of about 9 ft 6 in (2.9 m) or 4-ft 3-in (1.3 m) or 8 ft 6 in (2.6 m). A modular design may also be crafted fit any other various standard containers, such as air freight containers. The modular design may provide flexibility for the energy storage system to fit within pre-existing containers or structure.

A modular design may take advantage of existing refrigeration and air handling equipment attached to insulated containers as a complete HVAC solution.

Conventional cooling may be accomplished by properly placing cooling vents to the outside of the enclosure

In some embodiments, a battery system may include one or more battery modules, one or more electrolyte management systems, and one or more air cooling assemblies. In some embodiments, a battery module may include a top tray, bottom tray, and one or more cell stacks. In some embodiments, a stack of cells may include one or more layers or levels of cells. In some embodiments, one or more levels or layers of cells may include a single cell, a quad of cells, a plurality of cells, or a plurality of quads of cells. For example a layer may be made of an m×n array of cells or an m×n array of quads, where m and/or n may be selected from any whole number greater than or equal to 1, including but not limited to 1, 2, 3, 4, 5, 6, 7, 8, 9, 10, 11, 12, 13, 14, 15, 16, 17, 18, 19, 20, 21, 22, 23, 24, 25, or more. Each module may incorporate one or more parts of an electrolyte management system. In some embodiments, each quad may share one or more parts of an electrolyte management system.

In some embodiments, a module may be a 50 kW/300 kWh module. In other embodiments, a module may have any other power/energy. For example, a module may provide 10 kW or more, 20 kW or more, 30 kW or more, 50 kW or more, 70 kW or more, 100 kW or more, 200 kW or more, 300 kW or more, 500 kW or more, 750 kW or more, 1 MW or more, 2 MW or more, 3 MW or more, 5 MW or more, 10 MW or more, 20 MW or more, 50 MW or more, 100 MW or more, 200 MW or more, 500 MW or more, or 1000 MW or more. A module may also provide 50 kWh or more, 100 kWh or more, 200 kWh or more, 250 kW hr or more, 300 kWh or more, 350 kWh or more, 400 kWh or more, 500 kWh or more, 700 kWh or more, 1 MWh or more, 1.5 MWh or more, 2 MWh or more, 3 MWh or more, 5 MWh or more, 10 MWh or more, 20 MWh or more, 50 MWh or more, 100 MWh or more, 200 MWh or more, 500 MWh or more, 1000 MWh or more, 2000 MWh or more, or 5000 MWh or more.

FIG. 8B shows bottom portions of battery modules in accordance with an embodiment of the invention. The bottom portions may include one or more stacks 820 which may include one or more layers/levels 836 of cells. The battery module may include a battery stack support 824 beneath the layers of cells. The stack support may support the stack under a lower tank 822. The lower tank may be configured to contain electrolyte that may flow from the stacks. The stack support may be configured to prevent the electrolyte from contacting the bottom of the stacks, such as an air electrode at the bottom of the stack. In other embodiments, the stack support may allow electrolyte to contact the bottom of the stack but may provide support for keep the stack support suspended over portions of the lower tank.

In some embodiments, the lower electrolyte storage tank which may be thermoformed, may receive electrolyte overflow and assist in circulating the electrolyte within the battery system. For example, the lower tank may direct the electrolyte to a testing tank, and then to an upper tank, which may distribute electrolyte to one or more stacks. The lower tank may be fluidically connected to one or more fluid distribution members 826 which may include pipes, channels, or any other passage for distributing fluid known in the art.

A stack 820 within a battery module may include one or more layers or levels 836. A level or layer may include a frame 830. The frame may be injection molded or formed in any other manner. In some embodiments, a single integrally formed frame may be provided per layer or level. In other embodiments, multiple frames or separable portions of frames may be provided per layer or level. In some embodiments, a frame may include a portion of an electrolyte management system 832. The electrolyte management system may be integrally formed within the frame. When layers of the frames are stacked vertically, portions of the electrolyte management system may become aligned vertically and allow electrolyte to be distributed to the cells 834 within the layers.

A cell 834 may be formed as surrounded by a frame 830 and supported by an electrode 828. In preferable embodiments, the surface of the electrode forming the bottom portion of the cell may be a metal electrode. Electrolyte may flow into the cell and be supported by the electrode and contained by the frame. Any overflow of electrolyte may flow into the electrolyte management system 832 and may be distributed to an underlying cell, or may flow all the way to the lower tank 822.

FIG. 8C shows a plurality of battery modules in a battery system. In some embodiments, a battery system may include a housing which may include a floor 840 or base or one or more walls 842 or coverings. As previously mentioned, in some embodiments, a housing may be a standard container, such as a shipping container.

A battery system may include an electrolyte management system. In some embodiments, an electrolyte management system may include one or more tanks 844a, 844b that may assist with circulation of electrolyte within the system or a reserve or supply of water to ensure consistent electrolyte mix when evaporation occurs. These tanks may assist either with filtering electrolyte within the system or assist in providing additives to the electrolyte within the system. In some embodiments, one or more pumps, valves, or pressure differentials such as a positive pressure source, or negative pressure source may be used within the electrolyte system, thereby assisting electrolyte circulation. In some embodiments, the tank may have an inlet and/or outlet from the system. The inlet and/or outlet may be used to remove waste or filtered material, provide additives, vent gases or excess fluid, or provide fresh fluid into the system. In some embodiments, one or more electrolyte conducting members 846 may be provided within the battery system. The electrolyte conducting member may be a pipe, channel, or any other assembly capable of transporting fluid from tank to upper tanks of stacks directly or via a manifold. The electrolyte conducting members may transfer electrolyte from a tank 844a, 844b to one or more modules 850. In some embodiments, electrolyte may be transferred to an upper tray or tank of the module. In some embodiments, electrolyte conducting members may be used to transfer electrolyte from a module to a tank 844a, 844b. The electrolyte conducting member may transfer electrolyte from a bottom tray or tank of a module to a tank 844a, 844b.

The battery system may include an air flow assembly. The air flow assembly may cause air to be circulated within the battery system. In some embodiments, the air flow assembly may cause air to flow within the modules. In some embodiments, the air flow assembly may cause air to flow in air tunnels between the cells. In some embodiments, one or more air tunnels may be provided between each layer of a stack. In some embodiments, the air flow tunnels may be horizontally oriented. In some embodiments, air flow tunnels may be substantially horizontally oriented and/or may have a slight tilt (e.g., 1 to 5 degrees). An air flow assembly may include a fan, pump, pressure differential such as a positive pressure source or negative pressure source, or any other assembly that may cause air to flow. In some embodiments, an air flow assembly may cause air to flow within tunnels of one or more modules. In some embodiments, air may flow between tunnels of different modules. Cells may be configured so that air tunnels may be continuously formed between adjacent cells and/or adjacent modules. In other embodiments, breaks in the tunnel may occur between cells and/or between modules.

In some embodiments, the battery system may also include one or more inverter banks 848. The inverter bank may convert DC to AC power.

FIG. 8D shows a top view of a battery system including a plurality of battery modules. As previously described, a housing may be provided for the battery system. The housing may include a floor 860 and/or a covering or door 862 which may include walls or ceiling. One or more tanks 864 or electrolyte conducting member 866 such as a pipe may be provided. The electrolyte conducting member may fluidically connect the tank with one or more modules 870. In some embodiments, each module may be directly fluidically connected to the tank via the electrolyte conducting member. In some other embodiments, one or more modules may be indirectly connected to the tank via other modules. In some embodiments, an electrolyte conducting member may be connected to one or more modules at the top of the module. The electrolyte conducting member may be configured to provide electrolyte to a top tray of one or more modules.

Any number of modules 870 may be provided within a battery system. For example, one, two, three, four, five, six, seven, eight, nine, ten, eleven, twelve, thirteen, fourteen, fifteen, sixteen, seventeen, eighteen, nineteen, twenty, twenty-on, twenty-two, twenty-three, twenty-four, twenty-five, twenty-six, twenty-seven, twenty-eight, twenty-nine, thirty, or more modules may be provided within a battery system. In some embodiments, a battery system may be a 1 MW, 6 hour energy storage container. In other embodiments, the battery system may be a 100 kW, 200 kW, 300 kW, 500 kW, 700 kW, 1 MW, 2 MW, 3 MW, 5 MW, 7 MW, 10 MW, 15 MW, 20 MW, 30 MW or more system. In some embodiments, the battery system may be a 1 hour, 2 hour, 3 hour, 4 hour, 5 hour, 6 hour, 7 hour, 8 hour, 9 hour, 10 hour, 11 hour, 12 hour, 13 hour, 14 hour, 15 hour or more system.

In some embodiments, for a standard module, one or more of the following characteristics may apply: the system may have features such as 500 k-2 MW, 2-12 MWH, and it is anticipated that the system would have a low cost. Such features are provided by way of example only and does not limit the invention.

The modules may have any configuration within the battery system. For example, one or more rows and/or columns of modules may be provided. In some embodiments, an array of modules may be provided. For example, two rows of 12 modules each may be provided.

In some embodiments, an electrolyte conducting member may be a pipe that may pass over each module. In some embodiments, the pipe may fluidically communicate with each module at the top of the module. The pipe may transfer electrolyte to the upper tray of each module. In some embodiments, the pipe may pass as a straight pipe over a first row of modules, then may bend and turn around and pass as a straight pipe over a second row of modules. Alternatively, the pipe may have any other bending or zig-zagging configuration.

In some embodiments, the battery system may also include one or more inverter banks 868. The inverter bank may convert DC to AC power.

FIG. 8E shows an example of a battery system including an air flow assembly. A battery assembly may have a container with a front end and a back end. In some embodiments, the container may be thermally insulated and/or electrically insulated. In some embodiments, the container may be a standard container, such as those previously described, or a reefer container. In some embodiments, the container may be about 40 feet long.

One or more modules may be contained within the container. In some embodiments, up to 36 modules may be provided within the container. The modules may be laid out in the container so that two rows of modules are provided, each row having 12 modules. Thus, a battery system may have an arrangement that is 12 modules deep and 2 modules wide. In some embodiments, 1800 quad cells may be provided per module. A module may be 120 cells high (e.g., having 120 layers or levels) and may have 15 quad cells per layer or level. In some embodiments, a battery system may have a total of about 50,000 quad cells.

FIG. 8E provides an example of an air flow assembly. An air flow assembly may be provided within a container. The floor of the container A may include t-bars, grooves, channels, protrusions, ridges, or other shapes. A lower air flow manifold B may be provided or T-flooring may be utilized in some reefer containers. In some embodiments, air in the lower manifold may flow laterally. In some embodiments, air may flow toward a center aisle C of the air flow assembly. In some embodiments, air may rise in the center aisle. One or more air tunnels D may be provided for one or more modules. The air tunnel may have a horizontal orientation. The air tunnels may be provided as part of centrodes of cells. Air may flow from the center aisle, into one or more air tunnels which channel air laterally between cells.

From an air tunnel D, air may laterally flow to a peripheral aisle E. One or more peripheral aisles may be provided. In some embodiments, two peripheral aisles E, F may be provided. Air may rise along the peripheral aisles. A peripheral aisle may be provided between a module K and a container wall I. In some fan or air circulation or exulsion system embodiments, an upper air manifold H may be provided with an upper air manifold casing G. The upper air manifold may receive air from the peripheral aisles. In some embodiments, a blocker J may be provided to prevent air from rising from the central aisle directly into the upper air manifold. This may force some of the air to flow to the air tunnels. In alternate embodiments, some air may rise from the central aisle into the upper manifold. In some embodiments, air may flow lengthwise along the upper air manifold. For example, air may flow from a side of the container with the utility area to the other end of the container.

FIG. 8F provides an additional view of an air flow assembly. An air flow assembly may be provided within a container. The floor of the container A may include t-bars, grooves, channels, protrusions, ridges, or other shapes. Air may flow along the spaces provided on the floor between the floor features. A lower air flow passage or tunnel B may be provided. In some embodiments, air in the lower passage may flow laterally. In some embodiments, air may flow toward a center aisle C of the air flow assembly. In some embodiments, air may rise in the center aisle. One or more air tunnels D may be provided for one or more modules. The air tunnel may have a horizontal orientation. The air tunnels may be provided as part of centrodes of cells. Air may flow from the center aisle, into one or more air tunnels which channels air laterally between cells.

From an air tunnel D, air may laterally flow to a peripheral aisle E. One or more peripheral aisles may be provided. In some embodiments, two peripheral aisles may be provided. Air may rise along the peripheral aisles. A peripheral aisle may be provided between a module and a container wall I. In some embodiments, an upper air manifold J may be provided with an upper air manifold casing. The upper air manifold may receive air from the peripheral aisles. In some embodiments, a blocker H may be provided to prevent air from rising from the central aisle directly into the upper air manifold. This may force some of the air to flow to the air tunnels. In alternate embodiments, some air may rise from the central aisle into the upper manifold. In some embodiments, air may flow lengthwise along the upper air manifold. For example, air may flow from a side of the container with the utility area to the other end of the container.

An upper electrolyte supply tank G may be provided as part of a module. A lower electrolyte receiving tank F may also be provided as part of the module. In some embodiments, the container I may rest on a surface K.

In some embodiments, supply air may be air provided through the floor and lower manifold. The supply air may then rise through the center aisle and flow through the air tunnels. Return air may right through the peripheral aisles and flow through the upper manifold. In alternate embodiments of the invention, air may flow in other directions (e.g., may be supplied from the upper manifold and may flow through air tunnels in opposite directions.

FIG. 8G shows an alternate example of an air flow configuration. In some embodiments, air may flow lengthwise along the container and need not be split up laterally. The air may or may not be circulated back lengthwise along the container.

In some embodiments, the modules may be placed on the floor of the container. In some embodiments, the floor of the container may have a floor T-bar. In some embodiments, the floor may have one or more grooves, channels, slots, protrusions, or ridges, which may support the modules while providing space below the modules. In some embodiments, air may flow within the space beneath the modules. This may help with temperature regulation.

In some embodiments, a utility area may be provided within the container and adjacent to the modules. For example, modules may be positioned within a container to provide a 6 by 7 feet utility area. In some embodiments, a user may be able to access the utility area. The user may be able to enter the container in the utility area. In some embodiments, the utility area may be provided at the rear end of the container.

In some embodiments, a plenum may be provided within a container. The plenum may protrude from a wall of the container at the front end. The plenum may be curved and may meet a module about halfway up. In some embodiments, an air supply may be provided at one portion of the plenum, and an air intake may be provided at the other portion of the plenum. For example, an air supply may be provided at the underside of the plenum, and an air intake may be provided at an upper portion of the plenum, or vice versa. In some embodiments, the air supply may include cold, treated air. The air supply may flow in a first horizontal direction through the modules provided on the supply side of the plenum. For example, if the air supply is provided on the underside of the plenum, the air may flow in the first direction horizontally through the lower half of the modules. The air may flow through one or more air tunnels of the modules.

When the air reaches the utility area at the other end of the container, the air may travel to the other portion of the modules. For example, the air may rise to the top half of the modules and flow in a second direction back toward the upper part of the plenum. In some embodiments, the second direction may be horizontal and/or may be opposite the first direction. The air may reach the return air intake at the upper portion of the plenum. The plenum may be provided at a front end of the container. Alternatively, the air need not circulate back and may be accepted by an intake at the utility area side of the container. The utility area side of the container may or may not provide a second air supply that may flow back to the first air supply. A carrier unit may also be provided at the front end of the container. The carrier unit may accept the air intake and may cool it, may vary and/or maintain the temperature of the air, may filter the air, and/or may vary or maintain the composition of the air.

### Balance of Plant Configurations

A. Electrolyte Circulation and Treatment Systems

As previously described and shown in FIG. 4A, an electrolyte circulation and treatment system may be provided, consisting of several components. In some embodiments, a separate balance of plant (air and water/electrolyte management system) may be provided. The electrolyte circulation and treatment system may include one or more of the following:
A device to deionize and filter supply water before entering the system.
A chemical tank to introduce and mix various salts and other chemicals with deionized water. This may form at least a portion of the electrolyte.
A tank or series of tanks that measures and treats battery electrolyte.
A pump or series of pumps that distributes electrolyte throughout the battery system.
Various sensors that measure and monitor total electrolyte volume, density, temperature, pH levels and other measures of the operation of the system.
Supply and return lines that distribute liquid electrolyte to and from the battery.
Various sensors and valves to control flow of liquid electrolyte and to control electrical connections from a control box.

FIG. 8H provides an example of a battery system within a container. One or more tank (e.g., treatment/holding tank, electrolyte tank) may be provided and may be connected to one or more modules via fluid connectors and valves. For example, electrolyte may be provided through a manifold, and then individually divided into separate fluid connectors that transfer the electrolyte to each of the modules within the system. For example, each upper tank of a module within the system may be in fluid communication with the manifold and may receive fluid therefrom. In some embodiments, one or more user interface may be provided.

In some embodiments, an air tight partition may be provided between the modules and the rest of the container. For example a service or utility area may be provided that an operator or other user may access. For example, a service aisle may be provided where an operator or other user can enter. In some embodiments, the service or utility area may include the tanks, user interface, or electronic controls. In one example, the air tight partition may separate the service or utility area from the modules.

B. Air Circulation and Conditioning Systems

FIG. 8A shows an example of an insulated cargo container and HVAC machine utilization in accordance with an embodiment of the invention. An energy storage system may include an air circulation and conditioning system consisting of several components. FIG. 8E provides an example of an air circulation system.

A series of airflow plenums may be provided to control and distribute the flow of air evenly between cells. Forced air cooling may be more effective than convection especially when coupled with good internal heat sinks and plenum style enclosure designs. Heated air may be removed from equipment enclosures by fans or blowers which may also draw cooler air into the enclosure through vents. Depending on cooling requirements, low to high volumes of air can be moved through the enclosure.

In some embodiments, one or more temperature sensors may be provided. Based on the temperature detected by the temperature sensor, the fans or blowers may be varied and/or maintained to control the rate of air flow. A fan system may be provided that forces air through the battery.

The system may include a fresh air make-up and filtration system to introduce oxygen, while filtering unwanted contaminants. In some embodiments, it may be desirable to have higher oxygen content than ambient air.

An HVAC system may be provided that measures and controls air temperature inside the battery housing.

The system may also include a humidity control system that humidifies or dehumidifies air within the battery housing. One or more humidity sensors may be provided. The humidity control system may vary and/or maintain the humidity of the air based on measurements from the humidity sensors.

In some embodiments, a series of sensors may be provided that communicate with various other systems.

C. Electrical Connectivity and Management

An electrical system may be provided that facilitates flow of power within the battery, and distributes power between the battery and the electrical grid or other power source. In some embodiments, the electrical system may determine whether to provide a flow of power between the battery and the electrical grid or other power source or sink. The electrical system may determine the direction and/or amount of power flow between the battery and the power source or sink.

D. Measurement and Control Systems

A centralized measurement system may be comprised of various sensors that are linked to a computerized control system. In some embodiments, the computerized control system may include one or more processors and memory. The computerized control system may collect the measurements gathered from the various sensors. The computerized control system may perform one or more calculations based on the measurements. Any algorithm, calculation, or other steps may be implemented using tangible computer readable media, which may include code, logic, instructions for performing such steps. Such computer readable media may be stored in memory. One or more processors may access such memory and implement the steps therein.

A computerized control system may be linked to various other mechanical systems. In some embodiments, the computerized control system may instruct one or more mechanical systems to perform an action. For example, the computerized control system may instruct a pump to pump a greater volume of electrolyte into a top tray. The computerized control system may instruct one or more valves, which may affect the distribution of the electrolyte between the plurality of modules. In another example, the computerized control system may cause a fan to blow at a slower rate. In some embodiments, the computerized control system may issue one or more instructions based on measurements received from one or more sensors. Any instructions may be provided by a controller via a wired connection or wirelessly.

A computerized control system may be linked to a phone and/or cellular communication networks. In some embodiments, the computerized control system may include a processing device, such as a computer. Any discussion of a processing device, or any specific type of processing device may include, but is not limited to, a personal computer, server computer, or laptop computer; personal digital assistants (PDAs) such as a Palm-based device or Windows device; phones such as cellular phones or location-aware portable phones (such as GPS); a roaming device, such as a network-connected roaming device; a wireless device such as a wireless email device or other device capable of communicating wireless with a computer network; or any other type of network device that may communicate over a network and handle electronic transactions. In some embodiments, the computerized control system may include multiple devices. In some instances, the computerized control system may include a client-server architecture. In some embodiments, processing devices may be specially programmed to perform one or more steps or calculations or perform any algorithm. A computerized control system may communicate over any network, including but not limited to, cellular communication networks, other telephone networks, a local area network (LAN), or a wide area network (such as the Internet). Any communications may be provided through a wired connection and/or a wireless connection.

In some embodiments, a user may interact with the computerized control system. The user may be remote to the computerized control system, and may communicate with the computerized control system over a network. Alternatively, the user may be connected locally at a user interface of the computerized control system.

E. Environmental Installation and Housing Configurations

Generally, modular batteries and its systems are not limited by size, volume or scale. Common industrial cabinets, containers, buildings and other structures can be configured to house the battery and its systems.

The battery and its support systems can be configured for mobile and stationary configurations. For example, the battery and its support systems could be provided in buildings, shipping containers, vessels and automobiles for example.

### Fuel Cell Configuration

In accordance with some embodiments of the invention, the energy storage system described elsewhere may be utilized in a fuel cell configuration. In a fuel cell configuration, each cell may be supported by a supply inlet and drain outlet valves for transfer or transfusion of electrolyte. In some embodiments, it may utilize the electrolyte transfer system of a gravity-based flow battery. For example, a supply inlet may be provided above a cell and a drain outlet may be provided below the cell. In other embodiments, groups of cells (such as quads or layers) may be supported by a supply inlet and drain outlet.

A fuel cell configuration may provide mechanisms that remove depleted electrolyte and add fresh electrolyte via a remote and convenient transfer or transfusion port.

### Market Adoption & Adaptation Scenarios

An energy storage system, which may include embodiments discussed elsewhere herein, may be advantageously used with green power generators. Examples of green power generators may include wind farms, solar farms, or tidal farms. An energy storage system may also be used with traditional power generators, such as fossil fuel steam generators or nuclear generators. In some embodiments, an energy storage system may store energy from a generator. In other embodiments, it may be able to supplement or shift the energy produced by a generator.

An energy storage system may be used in power distribution. For example, it may be used with regional electrical utilities, local electrical utilities, remote storage, and mobile storage.

An energy storage system may also have applications in power storage, management and back-up. For example, the energy storage may be used for governmental & military applications, commercial & industrial applications, community & institutional applications, residential & personal applications (fuel cell or battery). In some embodiments, excess energy may be stored in an energy storage system and used when needed. The energy storage system may be energy-dense to be located at suburban substations or urban basements.

Transportation applications may be provided for the energy storage system. For example, the energy storage system may be used to power locomotive & rail. The energy storage system may also be used for cargo shipping (on land or water). The energy storage system may also be used for mass transit & busing. For instance, the energy storage system may be provided as a fuel cell or battery on the mass transit vehicle. Similarly, the energy storage system may have automotive applications, and may be provided as a fuel cell or battery for an automotive vehicle. Preferably, the energy storage system on a vehicle may be rechargeable.

### Flattened, Four Sided Pyramid Cell Design Compensates for Changing Electrolyte Volumes

In rechargeable zinc air cells, electrolyte volumes typically do not remain constant. During cell discharge, as zinc metal (with relatively high density) is converted to lower density zinc species, electrolyte volumes may increase. During cell charge, the reverse reaction occurs and electrolyte volumes may decrease. Electrolyte volumes may also decrease due to water evaporation.

These changes in electrolyte volumes may adversely affect cell performance. If electrolyte volumes become too low, there may be insufficient conducting electrolyte between metal electrode and air electrode. This may cause an increase in cell resistance which in turn could adversely affect cell performance. Similarly, if electrolyte volumes increase too much, excess electrolyte may be forced into pores of the air electrode. Electrolyte penetrating and flooding air electrode pores prevents oxygen gas from readily diffusing (and becoming electrochemically reduced) inside the pores. Additionally, the increased electrolyte volume applies pressure on the air electrode and could cause mechanical deterioration of the electrode. This causes cell performance to deteriorate.

Controlling these constantly changing electrolyte volumes in an operating full battery stack may be accomplished by having a feedback mechanism that may automatically compensate for changes in electrolyte volumes. When additional electrolyte is needed by cells (for example, during cell charging when electrolyte levels decrease) electrolyte may be allowed to slowly drip from a reservoir into individual cells. During cell discharge, as electrolyte volumes expand, excess electrolyte within cells may be diverted via an overflow port to a reservoir for storage.

Previously described embodiments may include a four-cell, horizontal design that incorporates a fill port and exit port located at the junction where four horizontally positioned cells meet. This hollow fill/exit port may allow electrolyte to drip into and out of individual cells as needed. As a number of these four-cell assemblies are stacked on top of each other, the fill/exit port of the upper four-cell assembly may be positioned exactly above the lower four-cell assembly. This way, a number of vertically stacked four-cell assemblies may share a common fill/exit port that is connected to a common reservoir.

Another horizontal four cell design may be provided in accordance with another embodiment of the invention. The horizontal design may involve assembling a four cell assembly so that each cell in this assembly is slightly sloping (tilted) upwards (on one side only) towards the fill/exit port. This may physically compensate for gas evolution by allowing gas to more readily escape.

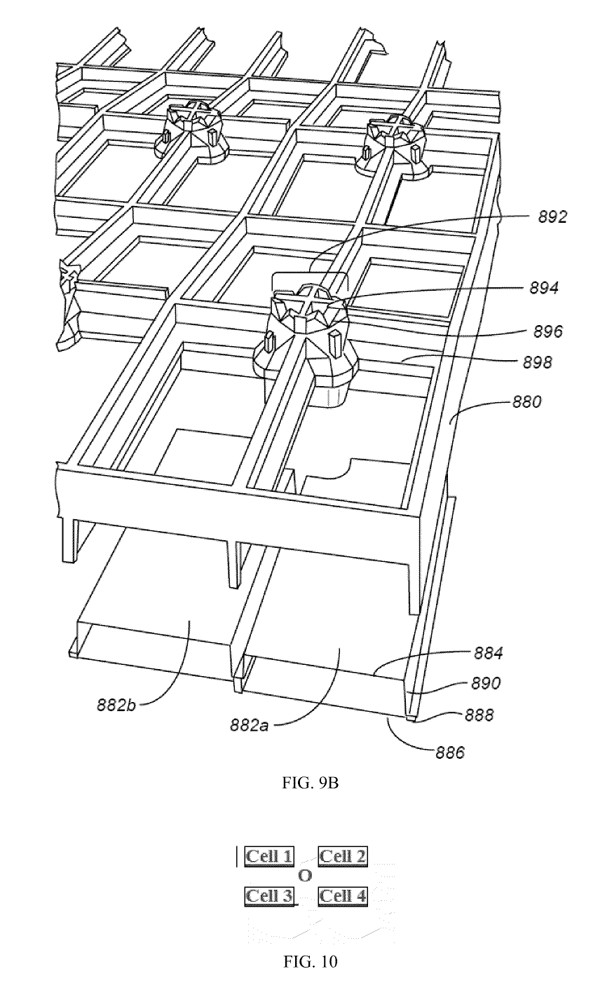

FIG. 10 illustrates the top view (looking down) on four cells (Cell 1, Cell 2, Cell 3, Cell 4) in a horizontal assembly. The cells may be positioned so that they share a common fill and exit port (indicated by O). The corner of each individual cell is slightly tilted upwards towards the O. Thus, the corner of each individual cell furthest from the O may be tilted downward.

Another way to visualize this design would be to imagine four individual cells positioned as a four sided pyramid (the top of the pyramid would be the point where all four cells meet) but instead of a sharp upwards incline as in a typical pyramid, this pyramid was flattened until tilt angles were only 1-5 degrees from horizontal. The tilt angle of each individual cell in the four-cell assembly may have any value, including, but limited to, 0.25 degrees or less, 0.5 degrees or less, 0.75 degrees or less, 1 degrees or less, 2 degrees or less, 3 degrees, or less 4 degrees or less, 5 degrees or less, 6 degrees or less, 7 degrees or less, or 10 degrees or less. Preferably, each cell may be tilted at the same angle, while in other embodiments, individual cells may be tilted at various angles. This flattened, four-sided pyramid design is intended to help electrolyte management and gas evolution during discharge/charge cycles.

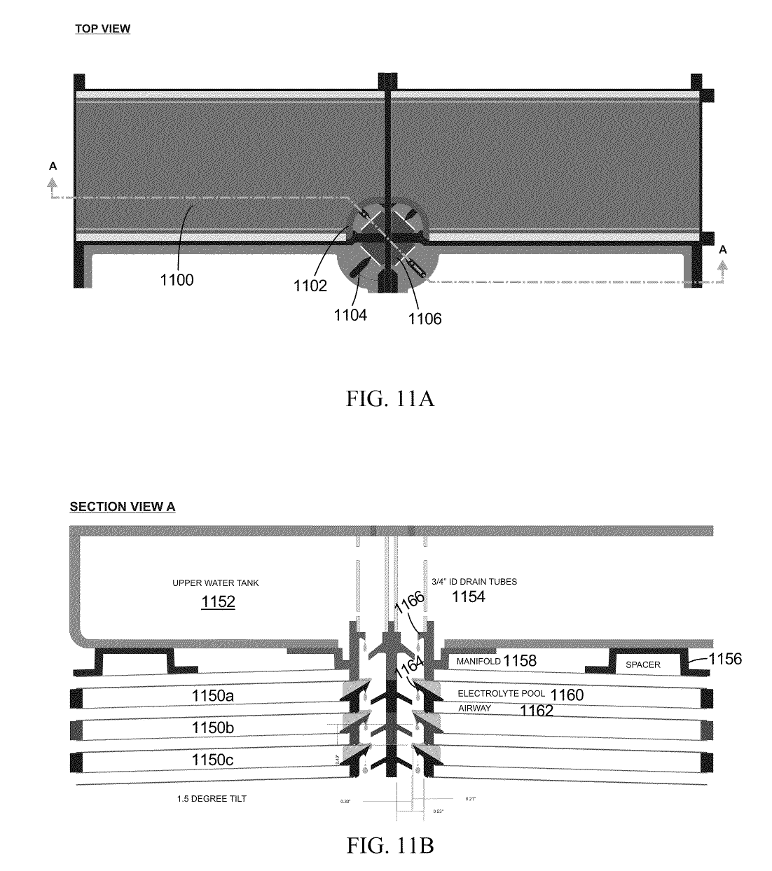

This is shown in the side view of FIG. 11B. Here, each of the cells 1150a, 1150b, 1150c in a stack assembly may be slightly tilted upwards from horizontal towards the fill port. In some embodiments, about a 1.5 degree tilt may be provided. An upper water tank 1152 may have one or more drain tubes 1154. The drain tubes may allow a controlled amount of electrolyte to flow from the upper water tank to the cells below. In some embodiments, ¾″ ID drain tubes may be provided.

The design may include one or more spacers 1156 within a manifold 1158. This manifold may provide a gap between the upper water tank and underlying cells. In some embodiments, a spacer may help sustain the gap between the upper water tank and individual cells. In some embodiments, the spacer may provide support between the cells and the upper water tank.

One or more flow control features 1166 may control the flow rate of electrolyte being provided from an upper water tank to underlying cells. In some embodiments, the flow control feature may protrude or may be vertically aligned. The flow control feature may break up electrolyte into small drops. In some embodiments, the flow control feature may keep an electrical connection from being formed between the electrolyte in the upper water tank and electrolyte in any one individual underlying cell. A drop from a flow control feature may be caught by an underlying cell. In some embodiments, underlying cells may have a port with an overflow portion. The flow control features may be vertically aligned over the overflow portion. The ports of the vertically aligned cells may also be vertically aligned. In some embodiments, the drop may flow into the electrolyte pool 1160 of the cell. Electrolyte from an upper cell may flow to an underlying cell. In some embodiments, each cell may have a cell flow control feature 1164 which may also control the flow of electrolyte being provided to underlying cells. The cell flow control feature may break the electrolyte into drops and prevent an electrical connection from being formed between the electrolyte in the cell and electrolyte in the underlying cell. In some embodiments, the flow control features may be in substantial vertical alignment with the flow control features of the cells above and/or below. Alternatively, they may have a staggered or other alignment. One or more airways 1162 may be provided between cells.

As previously discussed, individual cells may be tilted so that the portion of a cell receiving electrolyte may be tilted upwards. Electrolyte may flow from portion of the cell receiving the electrolyte towards the other end of the cell.

A slightly tilted cell orientation has a number of distinct advantages when cells are assembled into a stack. A first advantage is that a constant and reproducible cell resistance is still maintained between metal electrode and air electrode. This helps keep electrolyte resistance under tight control.

A second advantage involves managing gas bubble formation. During cell charge cycles, as water is being reduced, oxygen gas bubbles are necessarily generated. This tilted electrode design may allow these generated gas bubbles to easily migrate towards the upper portion of the electrode—near the electrode corner where they may then be safely vented. Having gas bubbles readily migrate to one side eliminates a potential problem of increased electrolyte resistance due to trapped gas bubbles in the electrolyte. A tilted design may be slightly angled to allow gas escape and facilitate slurry flow in a flow battery configuration.

A third advantage is that during charge cycles (when electrolyte is added from the reservoir to each individual cell), a tilted cell design allows added electrolyte to easily enter and fill each individual cell.

The tilt angle for each cell need not be large. It is clear that if tilt angles of individual cells were to be made too steep, added electrolyte would flow towards the bottom of the cell and flood the lower portion of the air electrodes.

A preferable tilt angle may fall within the range of only 1-5 degrees from horizontal. This may be sufficiently low so that electrolyte will not substantially gather in the bottom of each cell but any gas bubbles generated are diverted and rise towards the top opening of the assembly and can easily exit.

FIG. 11A shows an example of a top view of an energy storage system in accordance with an embodiment of the invention. In some embodiments, the energy storage system may function like a flow through cell. Alternatively, it need not function as a flow through cell. An upper water tank may have a floor 1100. A drain tube 1102 may be provided, allowing electrolyte to flow to one or more cells below. In some embodiments, one or more flow control feature 1104 may be provided to control the flow rate of electrolyte passing to underlying cells. In some embodiments, the flow control feature may break up electrolyte into drops. In some embodiments, a flow control feature may be provided for each underlying cell. For example, if four horizontally oriented cells (forming a quad) are sharing a common electrolyte management system, four flow control features may be provided. Each flow control feature may protrude over its corresponding cell. Any number of flow control features may be provided, which may or may not correspond to the number of underlying cells in the layer directly below. For example, one, two, three, four, five, six, seven, eight, nine, ten, or more flow control features may be provided.

A quad cell may also have a central portion which may be slanted downwards toward a cell. Any electrolyte that may fall onto the central portion may flow downward and to an underlying cell. In some embodiments, the central part may be injection molded.

One or more features, characteristics, components, materials, or steps known in the art may be incorporated within the invention, and vice versa. See, e.g., U.S. Pat. No. 4,168,349, U.S. Pat. No. 4,463,067, U.S. Pat. No. 5,126,218, U.S. Pat. No. 7,582,385, U.S. Pat. No. 7,314,685, U.S. Pat. No. 5,716,726, U.S. Pat. No. 4,842,963, U.S. Pat. No. 4,038,458, U.S. Pat. No. 5,242,763, U.S. Pat. No. 5,306,579, U.S. Pat. No. 6,235,418, U.S. Patent Publication No. 2006/0141340, U.S. Patent Publication No. 2008/0096061, PCT Publication No. WO 2007/144357, which are hereby incorporated by reference in their entirety.

### Example

In one example, a test cell may have been provided. FIG. 13 shows an example of cell voltage over test time in accordance with an embodiment of the invention. A test time of 350000 seconds was provided to demonstrate that the systems works.

A stable voltage range resulted with the early test cell. There was no physical degradation in the early version of the cell. For example, as shown in FIG. 13, the voltage remained relatively stable for 350000 seconds. For the most part, the voltage cycled between 0.9 and 2.1 volts.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A rechargeable metal air battery cell comprising:
a metal electrode;
an air electrode; and
an aqueous electrolyte between the metal electrode and the air electrode, wherein the metal electrode directly contacts the electrolyte and no separator is provided between the air electrode and the electrolyte.

2. The battery cell of claim 1 further comprising a frame supporting the metal electrode and the air electrode at a fixed distance from one another.

3. The battery cell of claim 1 wherein the fixed distance between the metal electrode and the air electrode defines a space in which the aqueous electrolyte is contained.

4. The battery cell of claim 1 wherein the metal electrode is a zinc based anode.

5. The battery cell of claim 1 wherein the air electrode is a carbon based oxygen cathode or a polymer based oxygen electrode, having an air permeable hydrophobic membrane; a corrosion resistant metal current collector; and wherein during electrical charging under anodic potentials, oxygen evolution is favored.

6. (canceled)

7. The battery cell of claim 1 wherein the air electrode is provided above the metal electrode.

8. The battery cell of claim 2 wherein the frame includes a shelf that protrudes within the cell and which contacts the metal electrode.

9. The battery cell of claim 1 further comprising an auxiliary electrode between the air electrode and the metal electrode or on both sides of the metal electrode, configured for cell charging and associated oxygen generation.

10. A rechargeable metal air battery cell system comprising:
a metal electrode;
an air electrode; and
an aqueous electrolyte solution having a pH in the range of about 3 to about 10,
wherein the battery cell system is capable of at least 500 discharge and recharge cycles without physical degradation of the materials or substantial degradation of the battery cell system's performance.

11. The battery cell system of claim 10 wherein the electrolyte is an aqueous chloride based electrolyte.

12. The battery cell system of claim 11 wherein the electrolyte is a mixture of soluble chloride salts having a cation suitable for yielding a soluble chloride salt in an aqueous solution.

13. A battery cell system of claim 10 wherein the electrolyte is a mixture of soluble salts based on at least one of the following: sulfates, nitrates, carbonates, hexyluorosilicates, tetrafluoroborates, methane sulfonates, permanganate, hexafluorophosphates, borates, or phosphates.

14. (canceled)

15. The battery cell system of claim 10 further comprising an additive that improves zinc deposition on the metal electrode compared to traditional battery cells, wherein the additive includes at least one of the following: polyethylene glycols of various molecular weights, or thiourea.

16. (canceled)

17. (canceled)

18. The battery cell system of claim 10, further comprising an additive that prevents foaming and allows gas release, wherein the additive includes at least one of the following: simethicone, Dowex, aloe vera, or other surfactants.

19. The battery cell of claim 10 further comprising an additive that prevents hydrogen evolution during charging.

20. The battery cell of claim 19 wherein the additive includes at least one of the following: high hydrogen overpotential chloride salts such as tin chloride, lead chloride, mercurochloride, cadmium chloride, or bismuth chloride.

21. The battery cell system of claim 10 further comprising an additive that prevents chlorine and/or hypochloride evolution during recharge, wherein the additive includes urea.

22. (canceled)

23. (canceled)

24. (canceled)

25. A battery cell assembly comprising:
a first cell having a first metal electrode, a first air electrode, and electrolyte therebetween; and
a second cell having a second metal electrode, a second air electrode, and electrolyte therebetween,
wherein the first metal electrode of the first cell contacts the second air electrode of the second cell so that an air tunnel is formed between the first metal electrode and the second air electrode and wherein the first metal electrode and the second air electrode are substantially vertically aligned and horizontally oriented.

26. The battery cell assembly of claim 25, wherein the first and second metal electrodes and the first and second air electrodes are housed in a substantially horizontal orientation.

27. The battery cell assembly of claim 25, wherein the first metal electrode contacts the second air electrode by being crimped around the second air electrode, thereby forming a centrode.

28. The battery cell assembly of claim 27, wherein the centrode provides a series connection between the first cell and the second cell.

29. The battery cell assembly of claim 25, wherein the first cell, the second cell, and one or more cells are vertically stacked and horizontally oriented, and selected to achieve a desired voltage.

30. The battery cell assembly of claim 25 wherein a horizontal gas flows within the air tunnel.

31. The battery cell assembly of claim 28 further comprising
a third cell having a third metal electrode, a third air electrode, and electrolyte therebetween; and
a fourth cell having a fourth metal electrode, a fourth air electrode, and electrolyte therebetween;
wherein the third metal electrode of the third cell is crimped around the fourth air electrode of the fourth cell so that an air tunnel is formed between the third metal electrode and the fourth air electrode, thereby forming a second centrode, and
wherein the second centrode is in electrical contact with the centrode providing a connection between the first and second cell.

32. An energy storage system comprising:
an electrolyte supply assembly having a flow control feature configured to distribute a liquid electrolyte to an underlying metal air battery cell; and
one or more metal air battery cells comprising at least one fill or drain port having an overflow portion,
wherein the flow control feature is vertically aligned over the overflow portion, and wherein flow control feature breaks the liquid electrolyte into drops.

33. (canceled)

34. The energy storage system of claim 32 further comprising a plurality of metal air battery cells, wherein the metal air battery cells are vertically aligned and stacked on top of each other, wherein the fill or drain ports of each of the metal air battery cells are horizontally oriented and stacked on top of each other, there by forming a continuous channel, and further comprising an electrolyte collection tray positioned below the one or more metal air battery cells.

35. (canceled)

36. (canceled)

37. (canceled)

38. (canceled)

39. (canceled)

40. (canceled)

41. (canceled)

42. A method for storing energy comprising:
receiving an electrolyte at an electrolyte supply tank;
allowing, if overflow occurs at the electrolyte supply tank, some electrolyte to fall from an electrolyte supply tank to an underlying first metal-air battery cell;
allowing, if overflow occurs at the underlying metal-air battery cell, some electrolyte to fall from the underlying first metal-air battery cell to a second metal-air battery cell or a collection tank—; —
removing the electrolyte removed from the collection tank;
treating the electrolyte removed from the collection tank; and
providing at least some of the treated electrolyte to the electrolyte supply tank.

43. (canceled)

44. (canceled)

45. (canceled)

46. (canceled)

47. (canceled)
